(19) United States
(12) Patent Application Publication
(10) Pub. No.: US 2025/0191792 A1
(43) Pub. Date: Jun. 12, 2025

(54) BOILING FUEL FAST NEUTRON NUCLEAR REACTOR

(71) Applicant: Maoz BETSER-ZILEVITCH, Calgary (CA)

(72) Inventor: Maoz BETSER-ZILEVITCH, Calgary (CA)

(21) Appl. No.: 18/973,099

(22) Filed: Dec. 8, 2024

(30) Foreign Application Priority Data
Dec. 8, 2023 (CA) 3222

(51) Int. Cl. G21C 7/02; G21C 3/54; G21C 3/56; G21C 11/06

(52) U.S. Cl. CPC G21C 7/02; G21C 3/54; G21C 3/56; G21C 11/06

(57) ABSTRACT

The naturally controlled temperature low-pressure fast neutron reactor maintains reactivity by evaporating and condensing nuclear fuel. The reactor evaporates a portion of the fissionable nuclear fuel when temperature exceeds the boiling temperature of the molten salt fuel. By the evaporation, the reactor controls the core reactivity chain reaction, preventing the temperature from exceeding the operation temperature. The evaporated fuel gas phase is condensed externally or internally. The reactor includes breedable materials like U238 and Thorium to generate additional fissionable fuel. Because of its inherent safety and simplicity, the reactor can be modernized into a small modular reactor and operate at a designed temperature controlled by the nuclear fuel chemistry. The reactor reflector can include ceramic solid particles of used nuclear fuel, U238, and Thorium.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention relates to a nuclear reactor.

### 2. Description of Related Art Including Information Disclosed Under 37 CFR 1.97 and 37 CFR 1.98

The current invention is a simple, self-controlled, fast nuclear reactor. The fast reactor, referred to as a “breeder” fast reactor, includes a nuclear reactor capable of generating more fissile nuclear fuel than it consumes. Such reactors are the closest thing to the “perpetual mobile” as their energy source is unlimited, efficiently tapping back to the ancient cosmic events that generated our planet's Uranium and Thorium heavy elements. In these reactors, the neutron economy is high enough to breed more fissile nuclear fuel (e.g., plutonium-239, Uranium 233, etc.) from fertile nuclear reactor fuel (e.g., uranium-238 and thorium) than it burns in a fission reaction. In principle, a breed-and-bum reactor may approach an energy extraction rate of 100% of the fertile materials, which is the most efficient manner to tap into and extract the energy of the cosmic events that pre-dated the formation of the sun. To initiate the breeding process, a breed-and-bum reactor must first be fed with fissile fuel, such as enriched uranium 235, plutonium, Uranium 233, etc.′. After that, breed-and-bum reactors may sustain energy production over decades without refueling. Another advantage of the fast neutron reactor is the nuclear waste compared to the moderated slow reactors. Due to the efficiency and the energy intensity, the reactor will “burn” the long half-life of nuclear waste, minimizing the nuclear waste storage requirement by an order of magnitude.

Given the advantages of the fast neutron reactor, it will be used instead of or together with the thermal reactors, which can only “tap” into the remaining declining 0.7% of Uranium 235 leftovers from the cosmic events that created uranium 238.No. U.S. Pat. No. 11,365,060 B2, entitled “Conveyor Module, Assembly, System, and Control,” issued to Michael C. McElligott on Jun. 21, 2022, is incorporated by reference herein.

### BRIEF SUMMARY OF THE INVENTION

The current invention is a method and a system for a simple self-regulated fast neutron reactor based on the fuel boiling chemical behavior. In one embodiment, the reactor comprises an internal cavity core, which becomes active and approaching criticality when it is partly filled with fissionable uranium and plutonium liquid salt. The core reactivity and temperature are controlled by the uranium and plutonium liquid salt expansion and boiling, maintaining the core reactivity and maximum temperature, which will balance the fuel evaporation temperature. The cavity is located in a reflecting and possibly futile breeding surrounding that can include packing of uranium oxide aggregate. The cavity can include a partly open sub-cavity containing the fuel vapor that can expand by further fuel boiling or contract by condensation to the surrounding cavity. The aggregate can be composed of used Uranium oxide fuel depleted in a slow neutron standard commercial reactor, including a high-efficiency slow reactor that burned most plutonium like the CANDU-type heavy water reactors. The additional long-live isotopes in the used fuel will be “burned” at the fast neutrons, which is an advantage from the perspective of nuclear waste. Another option is to use depleted uranium in the form of UO2 as the structure, packing aggregate, and fertile material. The aggregate can use uranium fuel with minimum processing. The ⅜″×⅝″ uranium oxide cylinders surround the critical void area and deflect the electrons while generating additional plutonium fuel and heat. The oxide's heat-resistant stability will also protect the structure elements from the intense temperature and radiation of the liquid boiling salt in the center of the mass criticality zone.

Another option is to use a liquid reflector and breeding zone around the reactive core. The reactor includes a critical void when partially filled with highly enriched molten Uranium or plutonium salts. The salt can include any halogen Fluoride, Chloride, Bromide, or Iodine. Chloride salt stability, melt and evaporation temperatures, and experience with molten Chloride salts make it an attractive option for boiling molten salt. The reactor will operate at low pressures, close to the atmospheric pressure. This is possible mainly due to the high temperatures, which allow high power generation efficiency and high-pressure, super-heated steam production. The high temperature and intense radiation limit the materials used to construct the reactor structure that can withstand pressure.

In addition, the low pressure increases the reactor's inherent safety by minimizing the risk of explosion. The reactor's reactivity is based on the reactor structure, the fuel reactivity, the molten salt expansion, boiling, and evaporation temperature. The reactor control is based on the evaporation-condensation balance of the fissionable fuel. The evaporated salt will reduce the liquid level and the criticality mass, so as long as liquid-enriched salt is recycled, the core will maintain the evaporation temperature. For example, for using UCl3 uranium salt, the boiling temperature of this salt is around 1657C, preventing the core temperature from exceeding this core temperature. Uranium oxide solids surround the hot boiling core, possibly with used fuel cylinders or other packing shapes. The molten liquid salt can flow between the uranium oxide particles, fill the voids, and recover heat. The fast neutron reaction will generate fissionable plutonium fuel from the non-fissionable U238 while generating additional heat. The reflecting and breeding area volume surrounding the core have lower reactivity as the highly enriched/fissionable active salt only fills the gaps between the solid packing. As an example, if the reactor will use enriched UCl3 salt fuel, the reactor temperature should be about 50C above 837C, which is the salt melt temperature if only UCl3 is used, and below the boiling temperature of 1657C, which is the boiling temperature of UCl3. Due to the potentially small size, low pressure, control simplicity, and inherent safety of the reactor, it can be modularized into per-built elements. It can also supply steam and heat to remote locations, such as steam for oil recovery like the SAGD.

### BRIEF DESCRIPTION OF THE SEVERAL VIEWS OF THE DRAWINGS

FIGS. 1-34 are schematic views of embodiments of the present invention.

FIGS. 35-37 are flow diagrams of steps of the method of the present invention.

### DETAILED DESCRIPTION OF THE INVENTION

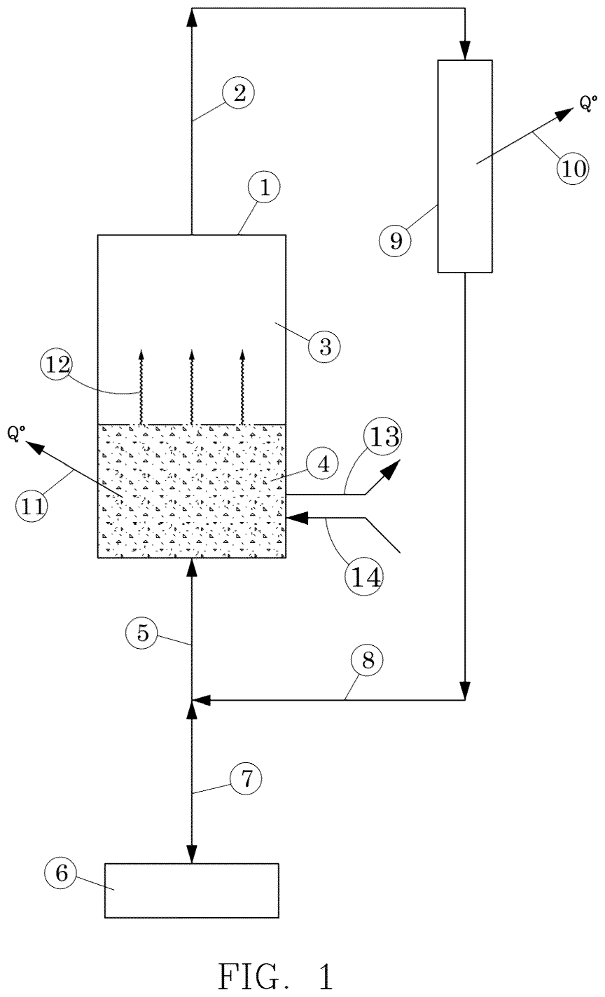

FIG. 1 shows an embodiment of the invention

A nuclear reactor enclosure 1 contains a liquid volume 4 and a gas volume 3.

The liquid volume contains the nuclear fuel in a liquid form of molten salt. The fissile nuclear fuel contains at least one of Uranium 235, Uranium 233, and Plutonium in a halogen salt chemical composition.

The temperature of the liquid salt fuel is maintained by evaporation of the fuel 12. The liquid level is based on the reactivity of the fuel. For more reactive fuel with less parasitic neutron poison, a lower liquid volume will be maintained so that the fuel evaporation will self-control the chain reaction. To reduce the cost and improve the reactor's safety, the reactor pressure is relatively low, close to atmospheric pressure. Still, as the temperature is very high, the thermal efficiency and the steam pressure can be achieved. The fissile uranium also contains Uranium 238, which will undergo fast neutron nuclear reactions to generate additional fissionable fuel. The reactor's temperature is based on the chemical properties of the nuclear fuel and Halogen. The temperature is the saturated evaporation and condensing liquid salt temperature where the fuel salt gas and liquid phases are in equilibrium at the given pressure (atmospheric or low gravitational pressure resulting from the molten salt liquid cover gravity pressure). For example, if the fuel includes fissionable UF4, the reactor's core center temperature will be controlled by the evaporation temperature of this salt, which is about 1417C. If, for example, fissionable UCl4 salt is used, the reactor temperature will be controlled by the evaporation temperature of the Uranium IV Chloride, which is a much lower reactor temperature around 791C. Another example is that for Plutonium Bromide PuBr3 nuclear fuel, the reactor temperature will be around 1463C.

The evaporated fissionable nuclear fuel 12 flows 2 from enclosure 1 to prevent over-pressure and potential explosion risk. Heat 10 is recovered from the nuclear fuel vapor 2 in heat exchanger 9. The condensed liquid fuel 8 is fed 5 back to reactor 1 to maintain the criticality chain reaction. The molten salt liquid fuel is fed back by gravitation or pump (not shown). The liquid content of the reactor can be drained through gravity 7 to an enclosure 6. The enclosure is designed to prevent criticality and include pump and heaters to handle the drained nuclear reactor enclosure content.

Heat 11 can be recovered from the reactor enclosure 1. The heat can be recovered by any of the following means or combinations: circulating a portion of the liquid 4 through an external heat exchanger, installing a heat exchanger within enclosure 1 to recover heat, or recovering the heat transferred through the reactor enclosure wall 1. The recovered heat can be used for any useful purpose, mainly to generate electric energy. Fissionable fuel 4 mainly includes fissionable Uranium, plutonium isotopes, and other Actinides. The fuel metals are chemically reacted with halogens selected from a group containing F, Cl, Br, and I to produce salts. The evaporating temperature of the fuel salt is controlling the reactor temperature. The fissionable fuel salts can be combined with futile/breedable salts of U 238 or Thorium, which also react with the halogens. The futile salts generate additional fissile material (additional fissile uranium and Plutonium) and act as neutron reflectors. The fuel can include additional passive salts from a group containing Pb, Bi, Na, Mg, K, Be, Li, and Ca halogen salts. The salts can be in an eutectic mixture to reduce the liquid fuel's melting point and control the core's reactivity. Theoretically, the fissionable possible salts can include any chemical combination salt of the main fissionable elements—Uranium and Plutonium with the halogen elements. As the main halogens include Fluorine, Chlorine, Bromine, and Iodine, and the possible stable salts are mainly two per element composition (UCl4 and UCl3, for example), there are 16 fissionable possible salts to choose from based on their chemical and nuclear properties. The same applies to the breedable/fertile/reflector salt, which includes any chemical combination salt of Uranium 238 and Thorium with the halogen elements. As the main halogens include Fluorine, Chlorine, Bromine, and Iodine, and the possible, stable salts are mainly two per element composition, there are possibly 16 Breedable/fertile/reflector salts to choose from based on their chemical and nuclear properties. In contrast to the fissionable Uranium and Plutonium elements, which at least a portion evaporates, the Breedable/fertile/reflector Uranium 238 and Thorium elements don't have to be included in a salt form (although naturally, when enriched uranium is used, it also includes the Breedable/fertile/reflector Uranium 238). They can be added in a solid form surrounding the reactor core center. This can include Uranium 238 and Thorium oxide ceramics (using thermal reactors used fuel components). Uranium 238 and Thorium nitrides ceramics can be used as well. It's also possible to use the U238 and Th in their metal form, possibly encapsulated in a protective layer to prevent chemical reactions with the molten salts and meltdown.

The table below shows some of the possible salts that can be used in the reactor:

| | Breedable/fertile/ | |
|---|---|---|
| Fission fuel salt | reflector salt | Passive/Filler/Eutectic salt |
| UCl4 | U238Cl4 | LiF, NaF, KF |
| UCl3 | U238Cl3 | BeF2, MgF2, CaF2 |
| UF4 | U238F4 | LiCl, NaCl, KCl |
| UBr4 | U238F3 | BeCl2, MgCl2, CaCl2 |
| UBr3 | UBr3 | LiBr, NaBr, KBr |
| UI4 | UBr4 | BeBr2, MgBr2, CaBr2 |
| UI3 | UI4 | LiI, NaI, KI |
| PuF4 | UI3 | BeI2, MgI2, CaI2 |
| PuCl4 | ThCl4 | PbO, PbF2, PbCl2, PbBr2, |
| PuCl3 | ThCl3 | ZrF4, ZrCl3, ZrBr3, ZrI3 |
| PuBr4 | ThF4 | Bi2O3, BiF3 |
| PuBr3 | ThF3 | CuCl, CuCl2, CuF2, CuBr2 |
| PuI4 | ThBr4 | SnF2, ZnF2, |
| PuI3 | ThBr3 | |
| | ThI4 | |
| | ThI3 | |

The fission fuel salt evaporation temperature will control the reactor temperature and reactivity.

For example, for a fissionable U235F4 and/or U233F4, the reactor temperature will be controlled by the boiling temperature of UF4, which is around 1417C. Due to the low pressure in the reactor, some expansion and evaporation will occur before the boiling temperature, which will also reduce the reactivity.

For a reactor where breedable futile salt is used (which is also a reflector due to the use of uranium or thorium salts), the evaporation temperature of the breeding salt should be equal to or higher than the evaporation temperature of the fissile fuel. As an example, for a fissionable U235F4 and/or U233F4, it is possible to use U238F4 (with the same evaporation temperature as the fissionable uranium and also ThF4 with a higher evaporation temperature). In this case, for example, ThCl4 and U238Cl4 cannot be used due to their lower evaporation temperature, which is lower than the evaporation temperature of the fissionable UF4.

Another consideration for a Fertile/reflector non-fissionable salt mixture option is the melting point of the Fertile/reflector salt mixture: the melting point should be equal to or lower than the evaporation temperature of the fissionable salt. It is possible to reduce the melting point, control the reactivity, and increase the volume and heat transfer efficiency by adding passive salts. Reducing the melting point substantially is possible using an eutectic salt mixture. Similar to the Uranium238 and Thorium fertile salts, the evaporation point of the passive salts should be similar to or higher than the evaporation temperature of the fissionable fuel salts. As an example, for a fissionable U235F4 and/or U233F4 fuel salt, it is possible to use LiF salt (as it evaporates at 1676C) or NaCl (boils at 1465) but not the passive reflective PbF2 salt as it boils at 1293C.

There are many other considerations when selecting the salts (nuclear properties (neutron cross-section and isotopes), stability, corrosion, cost, melting point, heat transfer, and so on, but the above limitations are specific to the present reactor invention with fissionable fuel boiler reactor. Another example is fissionable fuel of UCl4 with a boiling temperature of 791C with breedable salt of U238Cl4 with the same boiling temperature or with ThCl4 salt with a melt temperature of 770C or with U238Cl3 with a melt temperature of 837C and with eutectic molten salt mixture that include passive salt of PbCl2 with melt temperature of 501C that also performs as a reflector due to the lead and LiCl with a molten temperature of 605C and MgCl2 with a molten temperature of 714C. The use of passive salt reduced the neutron efficiency of the reactor as it increased the volume, and the passive materials could deflect and capture the electrons. The highest efficiency is to have a fissionable fuel in a mixture with a reflector and breathable element like U238 or thorium that will deflect the neutrons and generate additional fissionable fuel (plutonium for U238 or U233 for Thorium) as well as other materials at a lower concentration.

The reactor core can maintain its criticality over a large range of fuel reactivity as the amount of liquid 4 and the fill of the core can change substantially. Over time, the composition of the fuel will change as non-fissile U238 is converted to plutonium, increasing reactivity and reducing the amount of fuel needed to maintain criticality. The liquid reactive fuel with elevated levels of plutonium (and U233 if thorium is used) can bleed out from the reactor 13. At that point, it can be re-processed in the re-processing commercially proven facilities for use in slow neutron reactors as the fuel requirement is high for this reactor, and the fissionable element, as well as the other “poison” elements, have to be removed.

Due to the re-processing cost, the bled fuel 13 can be used with minimal re-processing in a new similar fast neutron molten salt reactor to allow the start-up of the new reactor so it can reach criticality. The bled fuel 13 is replaced with a non-fissile breedable fuel component that includes U238 to breed additional plutonium. Because of the non-sensitive nature of the proposed reactor and its ability to reach criticality over a wide range of fissionable and neutron poison waste, it's possible to use re-processed spent fuel reject or spent fuel that is not justifying re-processing (like heavy water CANDU reactor waste) and use it 14. This will provide a solution for the expensive nuclear disposal. For the first start-up of the new reactor, the fuel must include a high level of fissionable elements, mainly U235, plutonium, or U233, which makes the start-up expensive and complicated. The ability to allow the reactor to reach a high level of reactivity fuel 4, more than required for its operation with a high liquid level, allows removing reactive fuel 13 from a mature reactor and the use of this fuel for the start-up of an additional new reactor. Because that transfusion is between similar reactors that can operate with a wide range of fuel reactivity, there will be no need for expensive reprocessing. Reprocessing will be needed to use the produced fissionable elements (mainly plutonium) in a thermal neutron reactor. This mode of operation guarantees continuous and cost-effective operation as a mature reactor donates some of its extra fuel to start a new reactor, and so on.

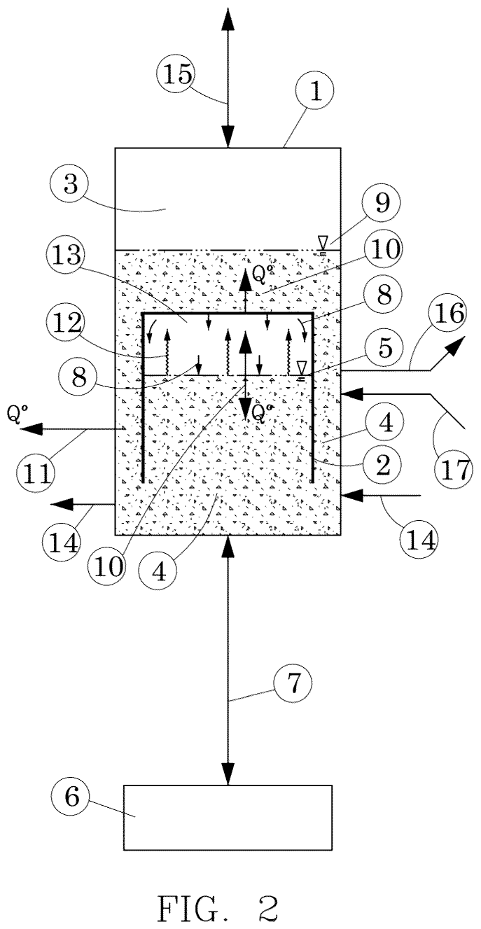

FIG. 2 shows another embodiment of the invention.

A nuclear reactor enclosure 1 contains a liquid volume 4 and a gas volume 3.

The liquid volume contains the nuclear fuel in a liquid form of molten salt. The fissile nuclear fuel contains at least one of Uranium 235, Uranium 233, and Plutonium in a halogen salt chemical composition. The temperature of the liquid salt fuel is maintained by evaporation of the fuel 12. The evaporated fuel in a gas form is trapped in the reactor core and replaced the liquid. Due to the much lower reactivity of the fuel gas phase, the reactor reactivity will decrease with evaporation and will stabilize around a steady state, which includes a certain trapped gas amount while maintaining the evaporation temperature balance. The trapped fuel gas phase can expand into the liquid fuel phase below it, preventing over-pressure. The reactor depends on the gravitation force that impacts the liquid phase and the gas phase of the fuel and maintains the separation of the heavier liquid at the bottom and the lighter gas phase at the top of the enclosure that traps it and prevents it from bubbling through the liquid phase above it. The trapped gas level controls the liquid level and is based on the reactivity of the fuel.

For more reactive fuel with less parasitic neutron poison, more fuel gas will be trapped, replacing the liquid so less liquid volume will be maintained, and the fuel evaporation will self-control the chain reaction. To reduce the cost and improve the reactor's safety, the reactor pressure is relatively low, close to atmospheric pressure, while the trapped evaporated fuel is close to the hydro-static pressure of the liquid fuel column above it. The saturated evaporation and condensing liquid salt temperature control the reactor core temperature, where the fuel salt gas and liquid phases are in equilibrium at the given pressure. The pressure will be slightly higher than the atmospheric pressure due to the molten salt liquid cover gravity pressure as level 5 is under level 9, and the liquid molten salt creates hydro-static pressure. Still, as the temperature of the core is the fuel evaporating saturated temperature, which is high compared to the common slow neutron water base reactors, the thermal energy efficiency and high steam pressure can be achieved.

The fuel can contain a non-fissile Uranium 238, which will undergo fast neutron nuclear reactions to generate additional fissionable fuel and act as a fast neutron reflector. The reactor's temperature is based on the chemical properties of the nuclear fuel. When the trapped evaporated fuel core fuel temperature increases above the evaporation temperature, more liquid fuel will evaporate, pushing liquid fuel outside the reactor core center and decreasing the core reactivity. The evaporated vapor gas partly filling enclosure 2 includes vapor of fissionable uranium salt (like U235) and fissionable plutonium salt that composed the liquid phase fuel 4. It is possible to further control the core temperature and reactivity by controlling the pressure of the trapped gas 13 by decreasing or increasing the pressure with a connection from the outside to the vapor volume 12 inside the internal gas trap 2. (the connection pipe is not shown).

To reduce the reactor's maximum temperature, inert gas (like helium, argon, CO2, nitrogen, argon, etc.) and be added to the internal volume, reducing the fissionable fuel's partial pressure and reducing its evaporation temperature. If sufficient inert gas is injected into cavity 13, enough fissionable fuel liquid will be replaced from the reactor core, reducing the reactor reactivity and shutting down the chain reaction without removing liquid fuel. The reactivity is maintained by a balance between the liquid and the vapor fissionable fuel within core 3 resulting from the molten salt evaporation temperature. For example, if molten salt includes uranium or plutonium tetra chloride, the core temperature will be maintained by the fissionable salt's relatively low (less than 1000C) evaporation temperature. In case the fuel includes uranium or plutonium fluoride, the maximum core temperature will be higher, as the boiling temperature of this fuel salt is higher. The vapor fuel in the core exchanges heat with the liquid fuel directly through the bottom and the enclosure volume wall. The liquid content of the reactor can be drained through gravity 7 to an enclosure 6. The enclosure is designed to prevent criticality and include pump and heaters to handle the drained nuclear reactor enclosure content.

Heat 11 can be recovered from the reactor enclosure 1. The heat can be recovered by any of the following means or combinations: circulating a portion of the liquid 4 through an external heat exchanger, installing a heat exchanger within enclosure 1 to recover heat, or recovering the heat transferred through the reactor enclosure wall 1. The recovered heat can be used for any useful purpose, mainly to generate steam and electric energy. Fissionable fuel 4 mainly includes fissionable Uranium, plutonium isotopes, and other Actinides. The fuel metals are chemically reacted with halogens selected from a group containing F, Cl, Br, and I to produce salts. The evaporating temperature of the fuel salt is controlling the reactor temperature. The fissionable fuel salts can be combined with futile/breedable salts of U 238 or Thorium, which also react with the halogens. The futile salts generate additional fissile material (additional fissile uranium and Plutonium) and act as neutron reflectors as well. The fuel can include additional passive salts from a group containing Pb, Bi, Na, Mg, K, Be, Li, and Ca halogen salts. The salts can be in an eutectic mixture to reduce the liquid fuel's melting point and control the core's reactivity.

The vapor fuel gas is trapped in the core center by enclosure 2, which is open at its bottom and closed from the top and sides to capture the bubble fuel vapor 12 to prevent the vapor-free bubble through the liquid medium upward. The enclosure vapor trap 2 material can stand the core heat, the melted liquid fuel salt, and the intense radiation. Because of the low pressure, the requirement to maintain a high strength is not as crucial as in a standard pressurized reactor, and so is the requirement for superb heat transfer allows the consideration of ceramic materials usage for trap 2 and enclosure 1. The trapped fuel vapor 13 exchange heat 10 with its surrounding liquid fuel 4. The heat is exchanged directly to the liquid at the bottom 5 or through containment wall 2. The core reactivity and the temperature determine the level of liquid 5.

As the temperature increases, liquid fuel in the core center becomes vapor 19 and trapped in enclosure 2. The gas-trapped volume pushed the liquid level 5 down and increased the liquid level 9. This geometry liquid core change reduces the core reactivity, which in turn reduces the core reactivity, reducing the temperature. When the temperature reduces, the opposite will happen, and fuel gas 13 will condense back to liquid 8. The gas volume is reduced, and liquid fuel flows to the core from enclosure 1, reducing the overall liquid level 9 but increasing the reactor's reactivity.

Because of the relatively wide range of reactivity, this reactor allows (as the liquid fuel level can change substantially) the fuel reactivity to vary in a wide range, allowing for less sensitivity for neutron poisons and fuel variations and minimizing the need for re-processing of the fuel. Reprocessing the fuel can be advantageous in recovering valuable plutonium fuel generated from U238 and reducing plutonium concentration to minimize plutonium burnout and maximize plutonium generation. The liquid level 5 can account for this and change over time. increasing its reactivity, reactor top gas volume 3 is maintained at a pressure close to atmospheric pressure. It might contain fuel vapor or blanket gas. Heat 11 is extracted from the constant temperature reactor. As more heat is extracted, the reactor will become more reactive to maintain the temperature of the trapped fuel gas 13, which allows less sensitivity to heat extraction and reactivity changes. The heat is extracted from the reactor core liquid phase through internal or external heat exchanger.

Liquid fuel 16 can be removed from the reactor for reprocessing or to use as fuel in a similar reactor. Non-fissile molten salt containing U238 and possible long-live isotope from used fuel is injected 17 into the reactor to reduce its reactivity and produce additional fissionable fuel, mainly plutonium, taking advantage of the wide range of criticality that is controlled by the liquid fuel level 5 that raise to increase the reactivity and drop to reduce the reactor reactivity. After replacing high-reactivity fissionable mature fuel 16 with non-fissile breedable and reflective fuel component 17, the liquid level 5 will rise until criticality is reached and the reactor stable around the fuel evaporation temperature.

The internal enclosure 2 is subjected to intensive radiation, temperature, and molten salt but not to high pressures as the system is maintained at a relatively low atmospheric pressure. In addition, it is not required to allow an efficient heat transfer through the enclosure wall 2, which is a key requirement in encapsulated fuel. This allows for the use of additional construction materials like zirconium oxide, which is an attractive material with its major problem being the poor heat transfer properties.

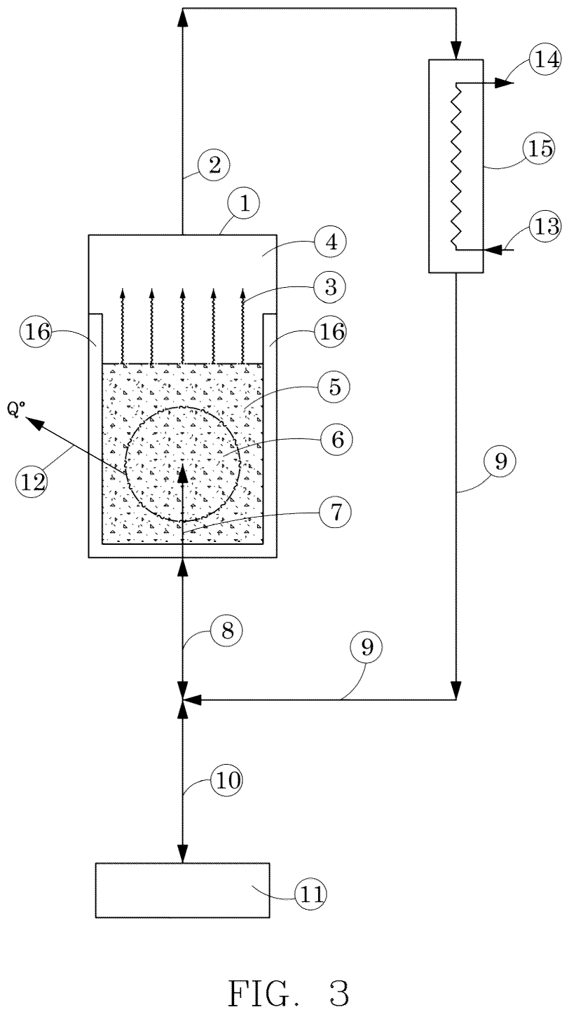

FIG. 3 shows an embodiment of the invention.

A nuclear reactor enclosure 1 contains a liquid volume 5 and a gas volume 4.

Enclosure 1 is surrounded by a solid or liquid neutron reflector (not shown) that can combine heat recovery from inside the reactor core. Liquid volume 5 contains a fissionable nuclear fuel and a fertile/breedable material of U238 or Thorium, which also performs as a liquid neutron reflector in the chemical form of a molten salt. Condensed fissionable fuel 7 is supplied into center volume 6. Volume 6, with its surroundings fissile and reflecting molten salt material, is sustaining the nuclear fission reaction. There is a flow of fissile fluids out of volume 6 to the surrounding molten salt 5. The condensed fissionable fluid 7 contains fissionable molten salts of at least one of U235, U233, and plutonium. The surrounding reflector and breeding liquid salt contains at least one U238 and Thorium. Volume 6 can be surrounded by a perforated barrier, or the flow pattern of the injected fissile fuel 7 can maintain it. The temperature of reactor core 1 is maintained by evaporation of excess fissionable fuel 3. The evaporation of the fissile fuel 3 reduces the core's reactivity as this material leaves the liquid phase 5 sufficiently dense to support the nuclear chain reaction. The reactor can include an internal layer of solid fertile Uranium 238 oxide or Thorium oxide, which reflects neutrons to the core center 6, produces additional fissionable nuclear fuel (mainly Plutonium or Uranium233), and protects the core external enclosure from the intense radiation and heat to extend its life.

The evaporated gas phase 4 is flow 2 to a condensed 15, where its evaporation heat is recovered while condensing back to a liquid phase 9. The condensed 15 includes a heat exchanger that heats a working fluid 13 to generate a hot working fluid. The condensed is designed to prevent criticality as it condenses high fissile liquid. The condensed fissile fuel is gravity-fed (or with the help of a pump (not shown) and can be directed 10 to the sump reservoir 11 or back to the reactor 8. Because the reactor reactivity is controlled by the evaporation temperature, it cannot exceed this temperature. Furthermore, as the reactor reactivity is the result of the temperature (and not the other way around where the temperature is the result of the reactor reactivity), the reactor is less sensitive to the fuel fissile reactivity (fuel enrichment) as more enriched fuel will result in increased evaporation and reduce the criticality liquid volume. The same applies to high levels of parasitic neutron poison, which the reactor will naturally compensate for by increased liquid volume and reactivity. A portion of the fissile and futile molten salt can be bled for re-processing by separating and removing isotopes and chemicals.

To reduce the reactivity and increase useful fuel production, plutonium can be removed from the fuel during the reactor operation and replaced with non-fissile uranium 238. Cadmium, for example, can be added to the molten salt. The cadmium will consume slow neutrons more likely to impact the fissionable fuel. This will decrease the reactor reactivity, allowing an increment in the fissionable percentage of the fuel. In addition to cadmium, other elements with large cross-sections for capturing slow neutrons can be used, as long they have a minimum impact on the fast neutrons, not competing with the interaction of these neutrons and the uranium.

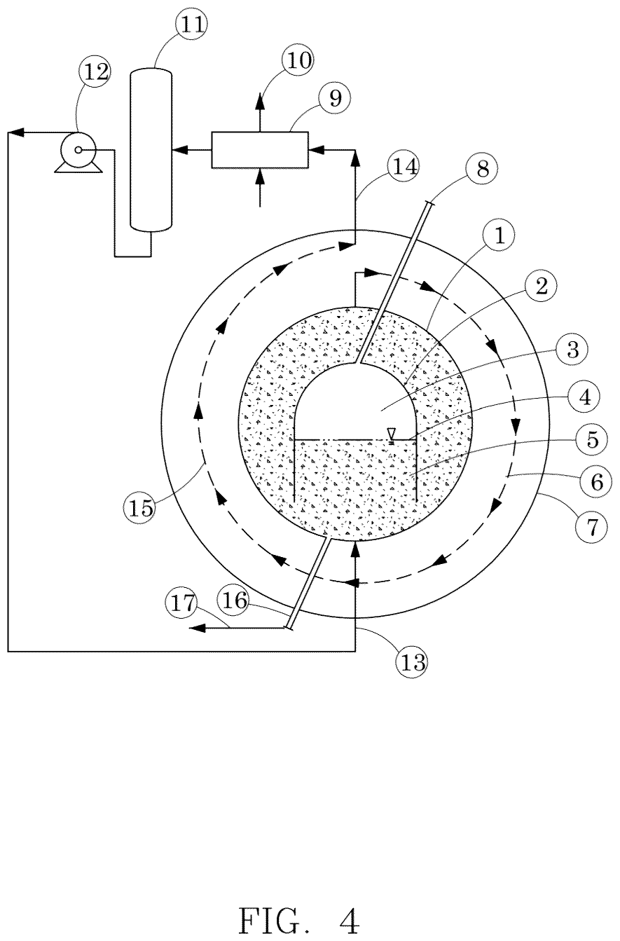

FIG. 4 shows another embodiment of the invention.

Nuclear fuel evaporator reactor enclosure 7 includes liquid molten fissionable salt 5. The liquid level 4 generates the chain reaction heat that boils the liquid nuclear fissionable fuel 5 from the liquid phase to a gas phase 3. The reactor core 1 contains an internal partial enclosure open at its bottom 2, partly filled with nuclear fuel vapor 3, trapped in the enclosure. The saturated fuel vapor is balanced with the fuel liquid and maintains a boiling temperature. Trapped gas can be removed from the internal enclosure 3 to remove any gas contamination generated during the reactor operation. The internal trapped vapor pressure and volume can be controlled as well through access 8, which can control the reactor reactivity and minimize fluctuation in the reactivity or reduce the operation pressure if inert gas like helium, CO2, oxygen, nitrogen, or other gases are added and reduce the fissionable fuel vapor pressure due to the partial pressure law for evaporation.

The reactivity of the core is maintained by the boiling temperature as in case the temperature drops, some vapor fuel will condensate back to the liquid phase, and the volume it occupied will be replaced by liquid fuel by raising the liquid level 4 and flowing of additional liquid fuel to the core increasing the reactivity and generating additional heat to reach the balance at the fuel boiling temperature. On the other hand, to reach the balance, the opposite will happen when the temperature increases and excessive heat is generated where liquid fuel 5 will evaporate into a gas phase fuel, 3, pushing the liquid level 4 down and decreasing the core reactivity because the reactivity of the fuel in the gas phase is substantially lower than the reactivity of the fuel in the liquid phase.

The nuclear core is surrounded by a layer of neutron deflector 6. The deflector can contain U238 or thorium to increase the neutron's economy and generate additional fissionable fuel over time in the surrounding deflector. The deflector can also be a passive deflector with no fertile materials like iron, tungsten, lead, and others. The liquid molten fuel at the saturated boiling temperature 5 leaves core 14, where it enters a heat exchanger 9 that recovers heat while heating a secondary working fluid 10. To minimize the delay of fission of the fuel 14 leaving the reactor core center where the radiation is most intense, it is possible to delay the circulating fuel in the reactor where the delay neutron release will occur within the reactor. One option is to circulate the fuel 14 through the reflector 6, delaying it's leaving the reactor, where delay neutrons will be released in the reflector 6 and not in the heat exchanger 9. The reactor core 1 is surrounded 7 by a reflector 6. The reflector can be a liquid or solid. It can be composed of fertile elements like thorium or uranium 238 that reflect the neutrons but also capture them, generating new fissionable fuel that can be used to generate additional energy. The reflector can also include passive material like lead, tungsten, and steel, which only reflect the escaping neutrons and do not generate additional fuel.

After the heat was recovered in the heat exchanger 9, the circulating nuclear fuel liquid at a lower temperature flowed to an accumulator 11 that, by design geometry, is always sub-critical. The liquid nuclear fuel is pumped 12 and recycled back 13 to the nuclear reactor, which is heated to the boiling temperature. The amount of heat energy that can be recovered from the mass of the nuclear fuel is the result of the difference between the boiling temperature and the melting temperature of the fuel. The fuel must be maintained at an elevated temperature above the solidification temperature, and the amount of recovered heat is based on this potential temperature difference (the high temperature 14 vs. the low temperature 13, which is higher than the solidification temperature).

Fuel can recover from the reactor core 17 through pipe 16. The fuel can be re-processed to recover fissionable material. Non-fissile fuel that contains U238 as well as other long-live radioactive elements can be injected into the reactor, where it replaces the removed fuel and decreases the fuel reactivity that will be compensated by rising of the liquid level 4. The reactor will maintain the fuel evaporation temperature and the fuel vapor balance 3. Core 1 is surrounded by a reflective layer 6. The reflective layer can include non-fissionable uranium and thorium to produce additional fissionable fuel from the fast neutrons escaping the core. Used fuel, re-processing fuel reject, or depleted uranium can also be used.

In another embodiment of FIG. 4, the reflective layer 6 can also include non-fissionable molten salt of Uranium and Thorium where the core surrounding wall 1 separates between the two fluids. Heat can also be recovered from the surrounding reflector 6 (not shown) and not just from the molten salt fuel circulation 13,14, as shown by pumping the reflector molten salt through a heat exchanger as shown for the fissionable fuel 5. To prevent freeze-up, the molten salt (fissionable fuel, reflector, and breedable) will be maintained well above the solidification point. The heat can recover directly to water or indirectly to a heat recovery liquid. Recovered heat 10 is used for steam production. The circulated molten salt fuel is accumulated in vessel 11 and circulated through pump 12 back to reactor 13. The circulated fissionable fuel salt 13 is maintained above the solidification temperature and heated due to the reactor reactivity to a temperature close to the boiling temperature. Energy recovery is the substantial difference between these two temperatures multiplied by the heat capacity of the liquid salt.

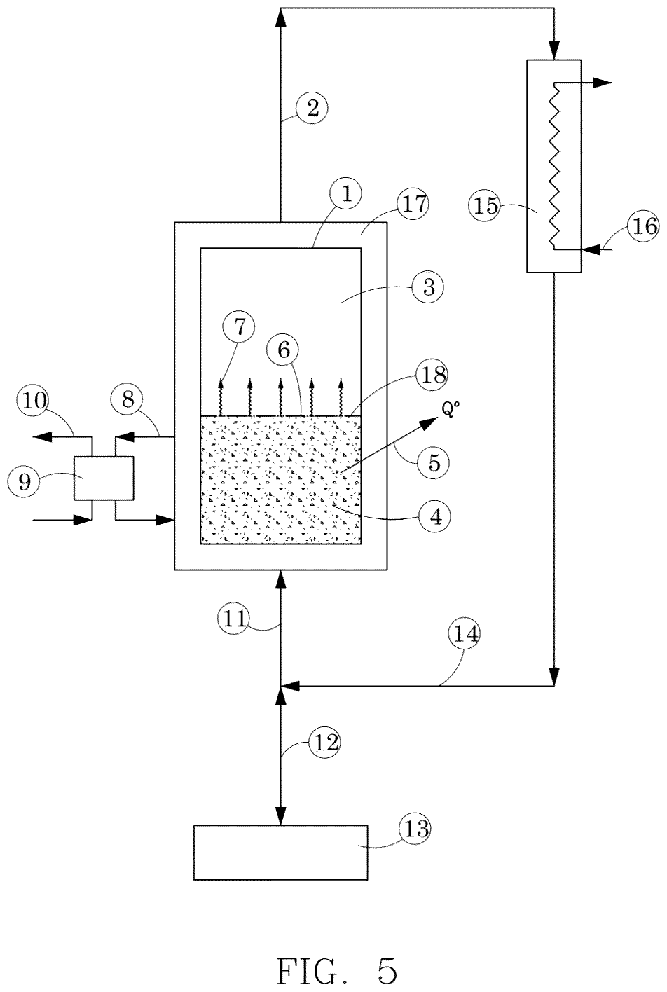

FIG. 5 shows another embodiment of the invention.

Nuclear reactor enclosure 1 includes a vapor-filled volume 2 that includes evaporated nuclear fissionable salt 3. The enclosure includes an external neutron reflector 17 that can also include a radiation shield. The reflector 17 can also be used to extract heat from the enclosure 1. The reactor enclosure includes a liquid salt core 4 that maintains its criticality when the liquid level approaches volume level 18. The temperature of liquid 4 is the boiling temperature of the fissionable liquid salt. The evaporated liquid 2, which contains fissionable nuclear fuel salt, is condensed in condenser 15 to recover heat to heat transfer fluid 16 and generate liquid molten salt 14. This liquid molten salt is re-introduced to the reactor 11. The reactor can be drained into a liquid salt reservoir 13 to avoid criticality. Liquid salt from 13 can be added or drained from the reactor 12. The liquid salt 4 includes fissionable salt containing fissionable uranium or plutonium. In addition, the fuel contains breedable salt that contains uranium 238 or thorium salts and possibly Benin salts that reduce the melting temperature of the salt's mixture, reduce the reactivity by increasing the volume and dispersing the heat, and improve the heat recovery from the reactor.

Heat can be recovered from the reactor by circulating molten salt into an external heat exchanger 9. The molten salt from reactor 8 transferred a portion of its heat to the working fluid 10, and this hot working fluid is used to generate high-pressure steam in an additional heat exchanger (not shown). The heat exchanger is located outside of the reactor, so it is less exposed to the neutron and other radiation. Radiation generated from the molten salt 8 will be directly drawn out from the reactor's critical core, but it is much less than the critical core radiation. This will increase the life expectancy of the heat exchanger 9. Heat is recovered from reactor 5 by the external heat exchanger 9 (described above), an internal heat exchanger (not shown), or heat recovered from reactor enclosure wall 1. If the reflector shield 17 includes liquid (like molten lead or lead-bismuth), heat can be recovered through a heat exchanger (not shown.)

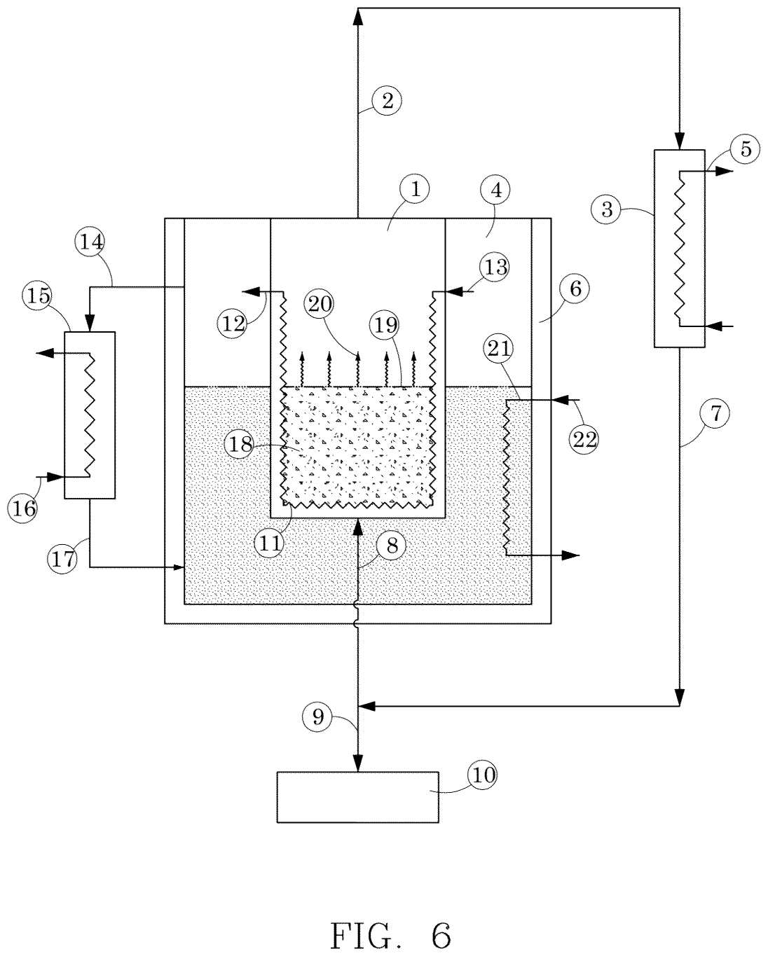

FIG. 6 shows another embodiment of the invention.

Nuclear reactor enclosure 1 includes liquid molten fissionable salt 3. The liquid level 19 generates the chain reaction heat that boils the liquid fissionable salt 20 and maintains the boiling temperature for the liquid phase 18 and the gas phase 20. Heat can be recovered from the fissionable liquid phase by heat exchanger 11 with circulating heat transfer fluid 12 and 13. The fissionable salt vapor 2 is condensed in condenser 3 back to the fluid phase 7 and recycled back 8 to the reactor core 18. The molten salt in the core includes fissionable material with U238 or thorium salts and possibly additional benign nuclear-molten salts that reduce the reactivity, reduce the melting point, and increase the heat removal potential.

The fissionable core 1 is surrounded by a separate volume 4. This volume is filled with molten breedable fertile neutrons reflecting salt that contains U238 or thorium molten salt. Additional benign salts can be included to reduce the melting point and improve the heat transfer potential. The salts in volume 4 have a higher boiling point than the fissionable salts in volume 1 as they do not change their phase and boil but maintain a liquid phase. Heat can be recovered from volume 4 by internal heat exchanger 21 with a heat transfer fluid circulation 22.

Another option is external heat exchanger 15, where liquid salt flow 14 from volume 4 is recycled through the heat exchanger and returned to volume 4. The heat is recovered to working fluid 16 for steam and electricity generation or for any other use where high-temperature heat is used. The reactor reflector and breading volume 4 generate fissionable fuel from the U238 or the thorium. The reactor can include an additional reflector or shield layer 6 that reflects or blocks neutrons and radiation and might also include a thermal insulation layer. As an example, 5% to 40% fissionable uranium 235 and 233 UCl4 fuel can be used as the evaporating liquid salt 18, possibly with additional U238Cl3 and other binning salts like LiCl, KCl, NaCl, MgCl2, PbCl, LiF and KF in possibly in an eutectic mixture. Additional fissionable Plutonium in the form of plutonium chloride can be included in the liquid molten salt mixture 18, increasing its reactivity and decreasing the amount of fissionable uranium tetra chloride needed for the liquid core reactivity. The maximum temperature of reactor 1 will be controlled by the boiling and phase change from liquid to vapor of the molten fissionable uranium tetra chloride fuel component. The reflector/breeder enclosure volume 4 includes U238Cl3 or ThCl4 with additional passive salts like PbCl2, LiCl, KCl, and MgCl potentially at an eutectic mixture to reduce the melting point and improve the heat recovery while still maintaining the high boiling point.

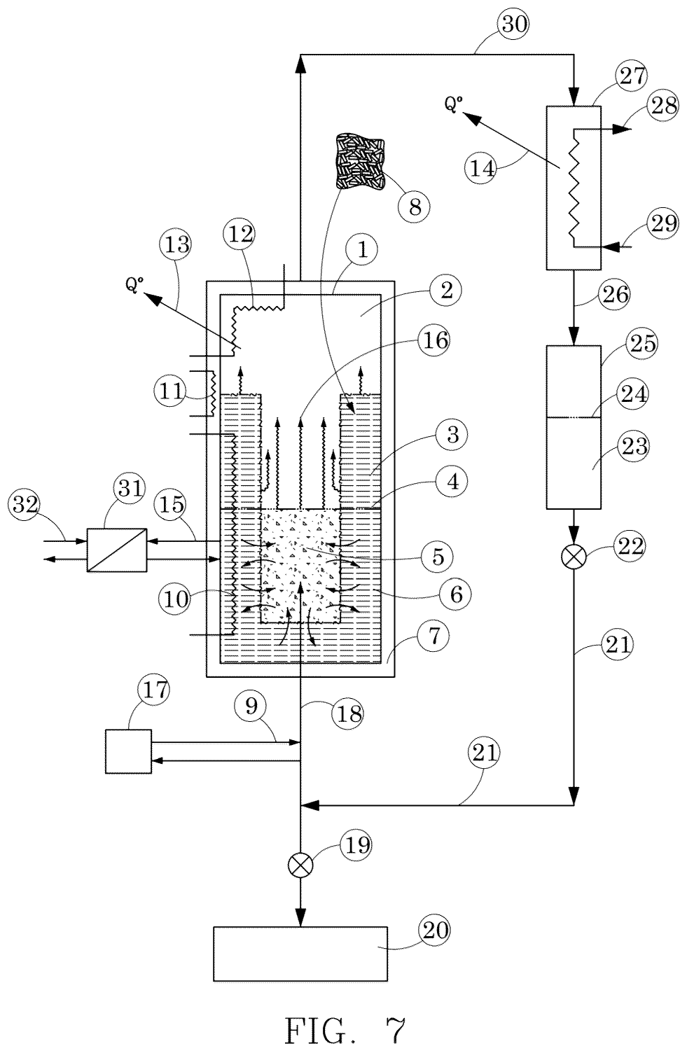

FIG. 7 shows another embodiment of the invention.

Nuclear fuel evaporator reactor enclosure 1 includes liquid molten fissionable salt 5. The liquid level 4 generates the chain reaction heat that boils the liquid fissionable salt 2 and maintains the boiling temperature for the liquid phase 5 and the gas phase 2. The reactor also includes a bottom drain tank 20, which drains the reactor content through control valve 19. The reactor includes non-critical reflecting barrier volume 3 surrounding the core center. This barrier volume allows the molten salt to flow through it. It can include Uranium 238 oxide and Thorium oxide, which reduce the reactivity of this surrounding volume, reflecting neutrons and producing additional fissionable fuel (Plutonium if U238 oxide is used and U233 if thorium oxide is used). The reflector volume can include uranium oxide packing elements (spheres, cylinders, rings, or any other geometrical shape). The packing can also include used nuclear fuel, typically cylindrical, which mostly includes U238 and contaminates that will be “burned” in the reactor producing energy. The packing filling is supported by eternal or internal support. The packing will consume 40% to 80% of the reflector volume, reducing the reactivity accordingly. As an example, if homogeneous molten salt containing uranium tetrafluoride is used, and the fissionable percentage of the molten salt is 20% U235, then for sphere packing of 0.6 U238O2, the reactivity for this volume when the gaps between the spheres will be filled with the liquid salt will be 8% in this volume.

Another option for reflector/breeding volume 3 is to form the uranium (or thorium) oxide into any stably supported shapes, like blocks formed into the required reflector shape. Uranium 238 oxide rods are composed of uranium oxide rings and are supported beside each other in a few rows to reflect neutrons and breed fissionable nuclear fuel (not shown). The molten salt 5 can flow 6 through the reflector/breeder 3, which is in fluid connection with the reaction core 5. If the molten salt is not chemically homogeneous (like if it consists of fissionable U235Cl4 with non-fissionable U238Cl3 and possibly nonreactive LiCl, Kcl, MgCl, and other fillers), the reactivity in volume 3 might be different due to the U235Cl4 lower boiling point in the surrounding molten salt 6 compared to the molten salt within the center of the core 5 due to the fissionable boiling 16 within the core center and the recycle of the condensed fissionable condensed molten salt fuel 18 to the core. As stated previously, the molten fuel salt temperature is lower or equal to the non-feasible salt (U238, thorium, and passive salts). The boiling temperature of the fissionable fuel components predominantly controls the salt temperature. As an example, for U235F4, the temperature of the vapor fuel will be around 1417C; for U235Cl4, the temperature of the vapor fuel will be around 791C; for PuBr3, the vapor temperature will be around 1463; and for U23514, the vapor 2 temperature will be around 758C. If PuCl4, PuF4, PuBr4, and PuI4 are used as the main fissionable boiling nuclear fuel, the vapor 2 temperature will be related to and controlled by their boiling temperature. Vapor 2, including the fissionable nuclear fuel, flows 30 from the boiler reactor 1 to condenser 27.

Heat 14, including the condensation heat, is recovered from the gas phase to the liquid phase. Heat exchanger 28 29 within the condenser recovers the heat for energy generation or any other useful use. The condensed liquid molten salt 26 is collected in liquid phase 23 in enclosure 25. The liquid 23 is fed back 21 to the reactor 1 through a control valve 22. The molten salt is fed 18 to the reactor by a gravity feed or a molten salt pump (not shown). Portion 9 of the recycled condensed molten salt 18 is reprocessed in a reprocessing facility to remove contaminates and isotopes and maintain the salt chemistry.

Heat 13 can be recovered from reactor 1 to generate steam for electricity production or any other use. Heat 13 can be extracted by a few means: Molten salt 15 can be circulated through an external heat exchanger 31 that will recover some of the molten salt heat to heat fluid 32, which can be intermediate heat transfer fluid or water. The core heat 13 can also be recovered by internal heat exchanger 10, which is in direct contact with the molten salt 5 and is located behind the neutron reflector 3 to reduce the radiation and core radiation and increase its life. Heat can also be recovered from the external neutron reflector and radiation shield layer 7. This layer can include lead or lead-bismuth liquid, and heat can be recovered by the heat exchanger 11. Another option is a solid external reflector shield from metallic uranium, steel, and other heat transfer metals. Shield metallic lead and other materials. Shield 7 can also include a layer that will block the escaping neutrons and include materials like hafnium, cadmium, and boron (not shown).

Heat 13 can also be recovered from the vapor nuclear fuel within the reactor enclosure 1. Internal heat exchanger 12 can recover heat from fuel vapor 16. The vapor fissionable fuel will condense to liquid molten salt. It will drip back to core 5, increasing the core liquid volume and reactivity, generating re-evaporation of the fissionable fuel to maintain the core boiling temperature. Nuclear fuel evaporator reactor enclosure 1 includes liquid molten fissionable salt 5. The liquid level 4 generates the chain reaction heat that boils the liquid fissionable salt 2 and maintains the boiling temperature for the liquid phase 5 and the gas phase 2. The reactor also includes a bottom drain tank 20, which drains the reactor content through control valve 19. The reactor includes non-critical reflecting barrier volume 3 surrounding the core center. This barrier volume allows the molten salt to flow through it. It can include Uranium 238 oxide and Thorium oxide, which reduce the reactivity of this surrounding volume, reflecting neutrons and producing additional fissionable fuel (Plutonium if U238 oxide is used and U233 if thorium oxide is used). The reflector volume can include uranium oxide packing elements (spheres, cylinders, rings, or any other geometrical shape). The packing can also include used nuclear fuel, typically cylindrical, which mostly includes U238 and contaminates that will be “burned” in the reactor producing energy. The packing filling is supported by eternal or internal support. The packing will consume 40% to 80% of the reflector volume, reducing the reactivity accordingly. As an example, if homogeneous molten salt containing uranium tetrafluoride is used, and the fissionable percentage of the molten salt is 20% U235, then for sphere packing of 0.6 U238O2, the reactivity for this volume when the gaps between the spheres will be filled with the liquid salt will be 8% in this volume.

Another option for reflector/breeding volume 3 is to form the uranium (or thorium) oxide into any stably supported shapes, like blocks formed into the required reflector shape. Uranium 238 oxide rods are composed of uranium oxide rings and are supported beside each other in a few rows to reflect neutrons and breed fissionable nuclear fuel (not shown). The molten salt 5 can flow 6 through the reflector/breeder 3, which is in fluid connection with the reaction core 5. If the molten salt is not chemically homogeneous (like if it consists of fissionable U235Cl4 with non-fissionable U238Cl3 and possibly nonreactive LiCl, KCl, MgCl, and other fillers), the reactivity in volume 3 might be different due to the U235Cl4 lower boiling point in the surrounding molten salt 6 compared to the molten salt within the center of the core 5 due to the fissionable boiling 16 within the core center and the recycle of the condensed fissionable condensed molten salt fuel 18 to the core. As stated previously, the molten fuel salt temperature is lower or equal to the non-feasible salt (U238, thorium, and passive salts). The boiling temperature of the fissionable fuel components predominantly controls the salt temperature. As an example, for U235F4, the temperature of the vapor fuel will be around 1417C; for U235Cl4, the temperature of the vapor fuel will be around 791C; for PuBr3, the vapor temperature will be around 1463; and for U23514, the vapor 2 temperature will be around 758C. If PuCl4, PuF4, PuBr4, and PuI4 are used as the main fissionable boiling nuclear fuel, the vapor 2 temperature will be related to and controlled by their boiling temperature. Vapor 2, including the fissionable nuclear fuel, flows 30 from the boiler reactor 1 to condenser 27.

Heat 14, including the condensation heat, is recovered from the gas phase to the liquid phase. Heat exchanger 28 29 within the condenser recovers the heat for energy generation or any other useful use. The condensed liquid molten salt 26 is collected in liquid phase 23 in enclosure 25. The liquid 23 is fed back 21 to the reactor 1 through a control valve 22. The molten salt is fed 18 to the reactor by a gravity feed or a molten salt pump (not shown). Portion 9 of the recycled condensed molten salt 18 is reprocessed in a reprocessing facility to remove contaminates and isotopes and maintain the salt chemistry. Heat 13 can be recovered from reactor 1 to generate steam for electricity production or any other use. Heat 13 can be extracted by a few means: Molten salt 15 can be circulated through an external heat exchanger 31 that will recover some of the molten salt heat to heat fluid 32, which can be intermediate heat transfer fluid or water. The core heat 13 can also be recovered by internal heat exchanger 10, which is in direct contact with the molten salt 5 and is located behind the neutron reflector 3 to reduce the radiation and core radiation and increase its life.

Heat can also be recovered from the external neutron reflector and radiation shield layer 7. This layer can include lead or lead-bismuth liquid, and its heat can be recovered by the heat exchanger 11. Another option is a solid external reflector shield from metallic uranium, steel, and other heat transfer metals. Shield metallic lead and other materials. Shield 7 can also include a layer that will block the escaping neutrons and include materials like hafnium, cadmium, and boron (not shown). Heat 13 can also be recovered from the vapor nuclear fuel within the reactor enclosure 1. Internal heat exchanger 12 can recover heat from fuel vapor 16. The vapor fissionable fuel will condense to liquid molten salt. It will drip back to core 5, increasing the core liquid volume and reactivity, generating re-evaporation of the fissionable fuel to maintain the core boiling temperature.

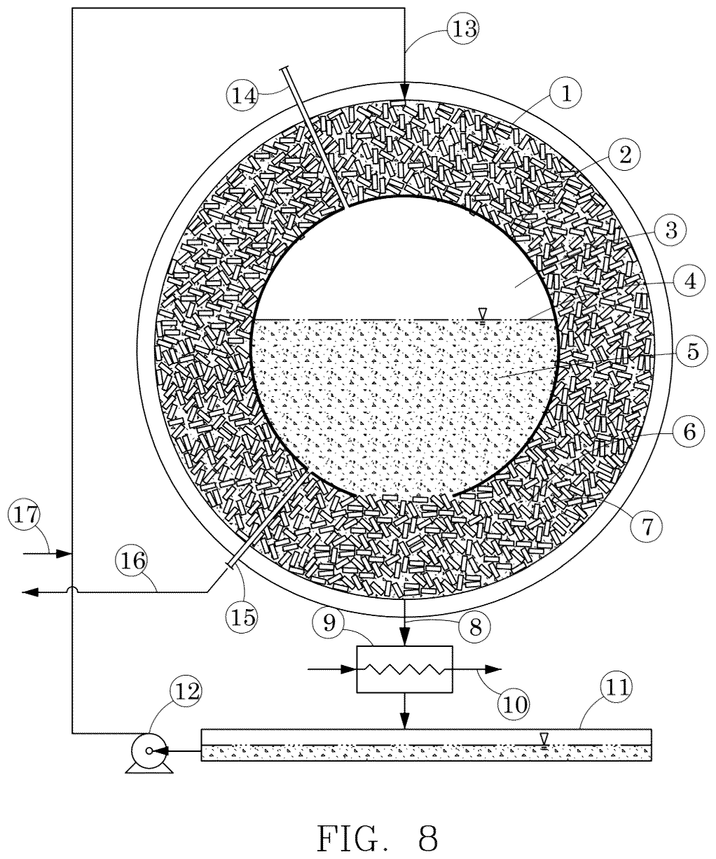

FIG. 8 shows another embodiment of the invention.

Nuclear fuel evaporated reactor enclosure 1 includes liquid molten fissionable salt 5. The liquid level 4 generates the reactivity necessary to maintain the chain reaction heat that boils the liquid fissionable salt 3 and maintains the boiling temperature for the liquid phase 5 and the gas phase 3. The fuel salt vapor is trapped in enclosure 2, which is open at its bottom to a free liquid fuel flaw. The amount of heat generated is controlled by the fuel evaporation temperature. An increase in fluid level 4 will result in increased reactivity that will evaporate additional fuel, and a decrease in fluid fuel level 4 will result in less reactivity, less heat generation, and a temperature drop. The core temperature will be maintained by the fuel boiling temperature independent of the amount of recovered heat from the reactor. The reactor includes reflecting barrier volume 6 surrounding the core center. This barrier volume includes solid particles that allow the molten salt to flow through it. It can include Uranium 238 oxide and Thorium oxide, which reduce the reactivity of this surrounding volume, reflecting neutrons and producing additional fissionable fuel.

The reflector volume can include uranium oxide packing elements (spheres, cylinders, rings, or any other geometrical shape). The packing can also include used nuclear fuel, typically cylindrical, which mostly includes U238 and contaminates that will be “burned” in the reactor, producing energy while producing additional fissionable fuel. The packing filling is supported in place by enclosure wall 2 and external enclosure wall 1. The packing will consume 40% to 80% of the reflector volume, reducing the reactivity accordingly. As an example, if homogeneous molten salt containing uranium tetra-fluoride is used, and the fissionable percentage of the molten salt is 20% U235, then for sphere packing of 0.6 U238O2, the reactivity for this volume when the gaps between the spheres will be filled with the liquid salt will be approximately 8% in this volume. Another option for reflector/breeding volume 3 is to form the uranium (or thorium) oxide into any stably supported shapes, like blocks formed into the required reflector shape. It is also possible to use heavy water reactor-spent fuel (like used CANDU fuel) that has minimal fissionable useful plutonium and parasitic elements, which currently makes re-processing this fuel uneconomical.

The molten salt 5 can flow through the reflector/breeder 7, which is in fluid connection with the reaction core 5. The fuel vapor enclosure trap supports the solid particles 7 surrounding the core. It is possible to design the reactor that in case of a failure in the enclosure trap 2, the solid elements 7 will fill the core center reducing its reactivity and shutting down the reactor. Even if the surrounding reflector breeding particles do not fill the core center, in case of failure in containment 2 that holds the vapor fuel gas 3, the fuel will boil, leaving the reactor until the reactor balances around the boiling temperature while boiling away any excessive fuel (not shown). Low pressure must be maintained to maintain the reactor safety, allowing the fuel vapor to leave the reactor and condense outside of the reactor at a lower temperature. The boiling temperature of the fissionable fuel 3 components predominantly controls the molten salt 5 temperature. It is possible to connect the internal gas volume 3 to the outside of the reactor to control the reactor reactivity and temperature by adding or removing gases from the core. If sufficient inert gas is added to the core, the reactor reactivity will decrease, and the chain reaction will stop.

The nuclear fuel 8 leaves the reactor at a high temperature, slightly lower than the boiling temperature. Heat is recovered from the liquid nuclear fuel in heat exchanger 9. The heat is recovered into a passive working fluid 10 that can be a eutectic molten salt mixture or any other working fluid suitable for high temperature (like sodium, lead, bismuth, indium, tin, cadmium, etc.′). After the heat was recovered from the cooler nuclear fuel, it flowed to an enclosure 11. In one embodiment, this enclosure is located at the bottom and can also be used to drain the nuclear reactor if needed. The molten nuclear fuel 13 is recycled back to the reactor with pump 12 and injected 13 to reactor 1 at its top, where it is heated by the reactive chain reaction and cooling the core, condensing saturated nuclear salt vapor 3 increase the liquid 5 level 4 and increase the reactivity and associated heat production within the reactor.

The reactor includes an additional external reflective or neutron-absorbing layer that can include lead, boron steel, or any other material that can shield radiation. The trapped gas and fuel vapor 3 can be controlled through access 14, where gas and vapor can be removed from the reactor, which will result in a rise in the liquid level 4 and an increase in the reactivity and heat that will evaporate liquid fuel to maintain the evaporation temperature in 3 and 5. Gas can be injected into the reactor core, reducing the evaporation temperature and reactor reactivity. Liquid fuel 16 can be removed from reactor core center 5 through access 15 for re-processing or for use in another new similar reactor. If fuel is removed, additional fuel components 17 will be added, mainly U238 in salt, with halogens like fluoride UF4, Chloride UCl3, UCl4, and others. The non-fissile U238 will be a core defector and breading source for generating fissionable plutonium.

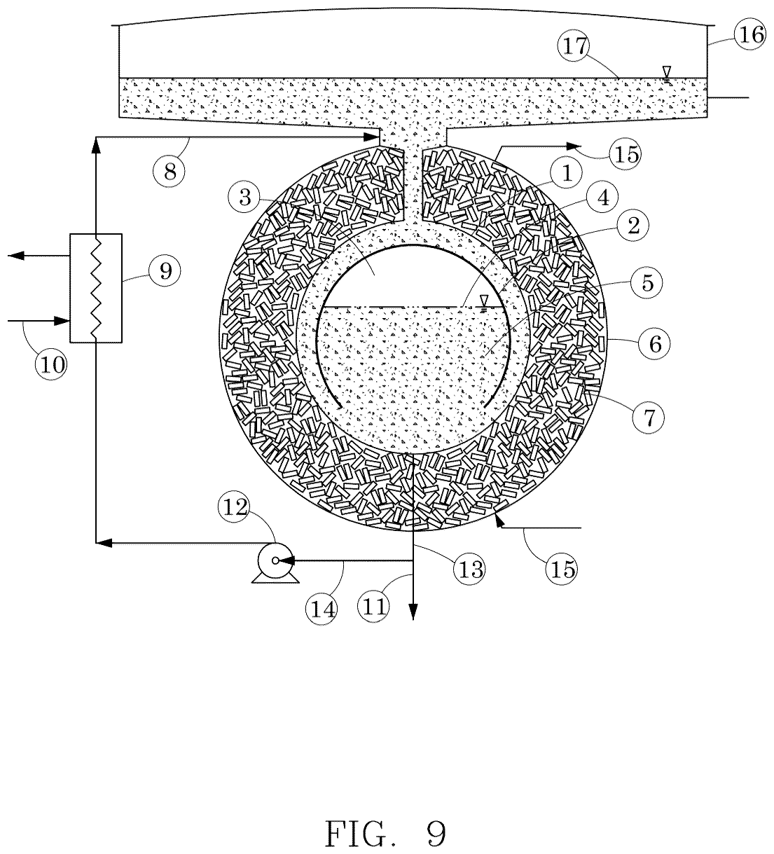

FIG. 9 shows another embodiment of the invention.

Nuclear fuel evaporating reactor enclosure 6 includes liquid molten fissionable salt 5. The liquid level 4 generates the reactivity necessary to maintain the chain reaction heat that boils the liquid fissionable salt 3 to a vapor gas phase and maintains the boiling temperature for the liquid phase 5 and the gas phase 3. The fissionable fuel liquid 5 and vapor 3 vapor include fissionable uranium salt and fissionable plutonium salt. The fuel salt vapor is trapped in enclosure 2, which is open at its bottom to allow free liquid fuel to flow in and out. The fuel evaporation temperature controls the amount of heat generated. An increase in fluid level 4 will result in increased reactivity that will evaporate additional fuel, and a decrease in fluid fuel level 4 will result in less reactivity, less heat generation, and a temperature drop. The core temperature will be maintained by the fuel boiling temperature independent of the amount of recovered heat from the reactor. When the reactivity of the reactor increases, liquid fuel is boiled, generating additional gas phase fuel 3, pushing liquid fissionable fuel 5 out from the core center 1 and into a liquid fuel reservoir 16 which is always sub-critical due to its structural dimensions and is partly filled with molten salt 17. The core is surrounded by a reflecting layer filled with non-falsifiable Uranium or thorium packing 7. The surrounding core is maintained in a gas (like CO2, nitrogen, air, argon, etc.′ gas blanket) 15. Liquid fluid (like lead-bismuth, tin, and Cadmium that will trap the slow neutrons) can also be used. Heat can be recovered from liquid fuel 13 and circulated 14 through pump 12 through heat exchanger 9, where a portion of the heat is recovered to working fluid 10 and back to reactor 8.

Another optional arrangement for FIG. 9 is using an all-liquid reflector and breeding layer that will be circulated through a heat exchanger instead of the fissionable fuel. In this arrangement, the reactor center volume 1 is surrounded by a larger volume of liquid breedable reflective and heat transfer 7 (without the ceramic solid elements shown). The internal volume includes liquid fissionable nuclear-molten salt fuel that includes PuCl4 and U235Cl4, which boils at a relatively low temperature of around 800C. The surrounding volume 7 can include U238Cl4 with the same boiling point as the U235Cl4 within the core center. It is also possible to add salts in an eutectic mixture to further reduce the melting point, like PbCl2. The surroundings can include low enrichment and generate Plutonium, which will breed over time and increase the reactivity. The surrounding volume is also performed as a neutron reflector and heat transfer liquid, as the liquid reflector fluid will be circulated through the heat exchanges instead of the fissionable fuel 5. Although in this arrangement, the reflector liquid 7 has the same boiling temperature as the internal volume fissionable fuel 5, which is maintained at the boiling temperature to control the reactivity and the heat generation, it should not boil because the intensity of the fission reaction and the associated heat production in the core 5 is substantially higher than in the surrounding 7 and the core heat is flowing to the surrounding volume 7 which will maintain a temperature gradient where the reactivity is maintained by the liquid volume 4 within the core center volume 2.

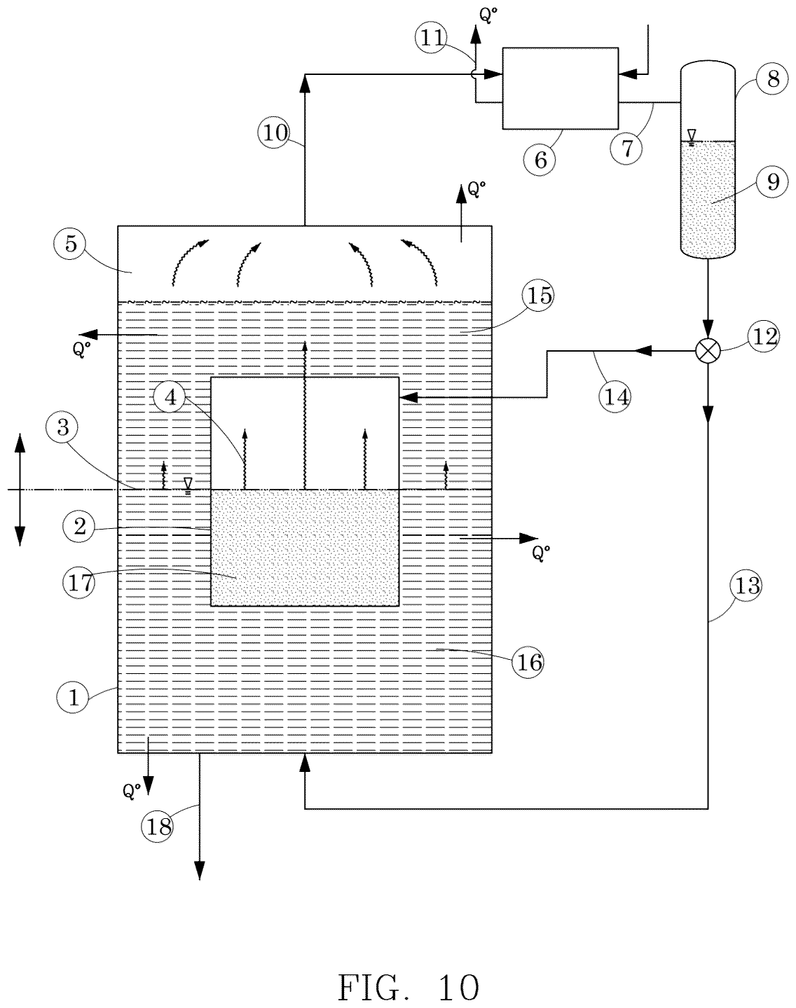

FIG. 10 shows another embodiment of the invention.

Nuclear fuel boiler reactor enclosure 1 includes an internal volume 2 partly filled with liquid molten fissionable salt. The internal liquid level 3 generates the nuclear chain reaction reactivity, which generates heat that boils the liquid fissionable salt 4 and maintains the boiling temperature for the liquid phase 17, 16 and the gas phase 15, 5. The reactor reactive volume 2 is surrounded by a non-critical volume 16, 15 that is partly filled with solid uranium 238 oxide, uranium nitrite, or carbide that reflects neutrons back to the internal volume 2 and produces fissionable plutonium fuel. Thorium oxide, nitrite, or carbide can also fill volumes 15 and 16 while generating fissionable U233 partly. The fill with the solid particles can include packing like spherical, cylindrical, ring, or any other packing. Rods, blocks, or any other filling can be used as well. The spaces between the packing and the fillings are filled with melted salt 16, which can flow between the critical space 2 and the surroundings volume 16.

The liquid level 3 within the reactor maintained just enough condensed liquid mass to maintain the reactivity to evaporate 4 portions of the fissionable molten salt to maintain the boiling temperature. The intense fast neutrons and other radiation increase the temperature in the surrounding non-critical surrounding volume 16, which also evaporates the liquid salt from a liquid phase to a gas phase. The evaporated salt flows through the reflective/fertile volume 15, where the vapor salt is filtered through the packing or other solid U238 oxide (or other solids as previously mentioned) reflection structure. This volume 15, 16 of reflecting and fertile uranium 238 produces heat, produces additional fissionable plutonium fuel, and reduces the radiation on the nuclear enclosure envelop 1, increasing its life and reducing the radiation protection requirements. Fissionable salt vapor 5 flows through the top section of the reactor to 10 condensers 6. The condenser 6 includes a heat exchanger that recovers the nuclear fuel condensation heat to the working fluid to generate energy.

The condensed liquid 7 is maintained in accumulator 8 in a non-critical manner. From the accumulator, the liquid-melted nuclear flow is controlled and directed 12. The molten salt is recycled back to reactor 13 to maintain the criticality 17. The fissionable molten salt 14 can be directed through the surrounding volume 16 17 and into internal volume 2, added to the reactive liquid 17 to maintain the criticality liquid level 3. during the reactor's start-up, the fissionable fuel will be directed directly to the internal volume 2 to reduce the pre-heating requirement and blockage risk due to the surrounding reflective mass 15, 16. Heat Q is recovered from the reactor and used to generate electric energy or for any other useful process usage. The reactor can be drained 18 for shut-down and maintenance.

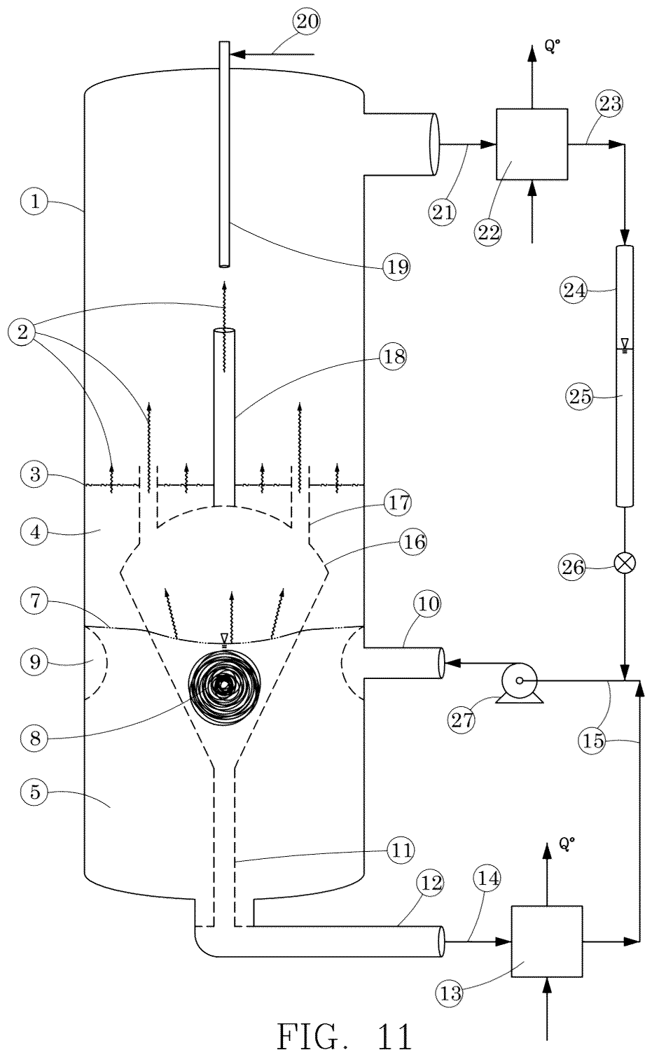

FIG. 11 shows another embodiment of the invention.

Nuclear fuel boiler reactor enclosure 1 includes an internal volume 16 partly filled with liquid molten fissionable salt 8. It maintains it is critical to generate sufficient heat to control the reactor temperature by boiling fissionable nuclear fuel salt to control the reactor core reactivity. The internal liquid level 7 generates the nuclear chain reaction reactivity, which generates heat that boils the liquid fissionable salt 2 and maintains the boiling temperature for the liquid phase 7 and the gas phase 2. The reactor reactive volume 16 is surrounded by a non-critical volume 5, 4 that is partly filled with solid uranium 238 oxide, uranium nitrite, or carbide that reflects neutrons back to the internal volume 16 and produces fissionable plutonium fuel. Thorium oxide, nitrite, or carbide can also partly fill volumes 5 and 4 while generating fissionable U233. The criticality chain reaction within the center mass 8 of volume 16 emits neutrons, radiation, and heat, which boils a portion of the liquid salt fuel and generates additional heat due to the intense radiation in the surrounding 5, which includes solid fertile U238 (or thorium) and molten salt-perforated conduit 11, collecting the molten salt within volume 5 and through pipe 12 at the bottom.

The molten salt 14, leaving reactor 11, flows through a heat exchanger 13, where a portion of its heat is recovered to a secondary heat transfer fluid for process or electric energy production. The molten salt 15 is then recycled through pump 27 back to reactor 10, spreading through perforated conduit 9 into the reactor. The return perforated conduit can be located in volume 5 (as shown), above it in volume 4 (not shown), or above it in volume 1. The molten salt heat transfer recycles shown is from top 10 to bottom.

Recycling the heat to recover molten salt in the opposite flow direction is also possible—pump it from 10 and feed it back after the heat exchanger at the bottom 12 (not shown). The internal volume 16 can include a few conduits that run through the surrounding reflector 4 for the boiled salt up flow. An additional opening 18 at the center allows a direct line from the core center 8 to the reactor top through the surrounding reflector/breeding volume 4. This allows monitoring the core 8, access to neutrons, and direct access to feed volume 16 with the nuclear-molten salt fuel 20 during start-up or injecting chemicals to control the reactivity. Molten salt fuel gas 21 flows through heat exchanger 22, where the condensation heat is recovered. The condensed molten salt liquid 25 is collected in container 24 and recycled back to the reactor through control valve 26. For example, if the controlling evaporate component within the molten salt is fissionable Uranium tetra Iodide U235/23313, its boiling point of 758C will control the maximum reactor temperature. Additional uranium 238 salts with higher boiling points, like Uranium tetra bromide, uranium chloride, etc.′ can be included, and additional filler salts like LiCl, KCl, LiF, and KF eutectic mixture to reduce the melting point and improve the heat transfer. In that configuration, all the components of the molten salt in reactor 1 will be recycled through heat exchanger 13. Still, only the Uranium tetra Iodide component within the salt (U238, 235, and 233) will be evaporated 21 and condensed 25. Instead of fissionable Uranium tetra Iodide, fissionable Uranium tetra Chloride can be used, where a boiling point of 758C will control the maximum reactor temperature but is sufficiently low so Uranium trichloride, Uranium tetra bromide, LiCl, KCl, LiF and KF can be used as part of the molten salt without boiling and condensing to minimize the vapor flow through the condenser.

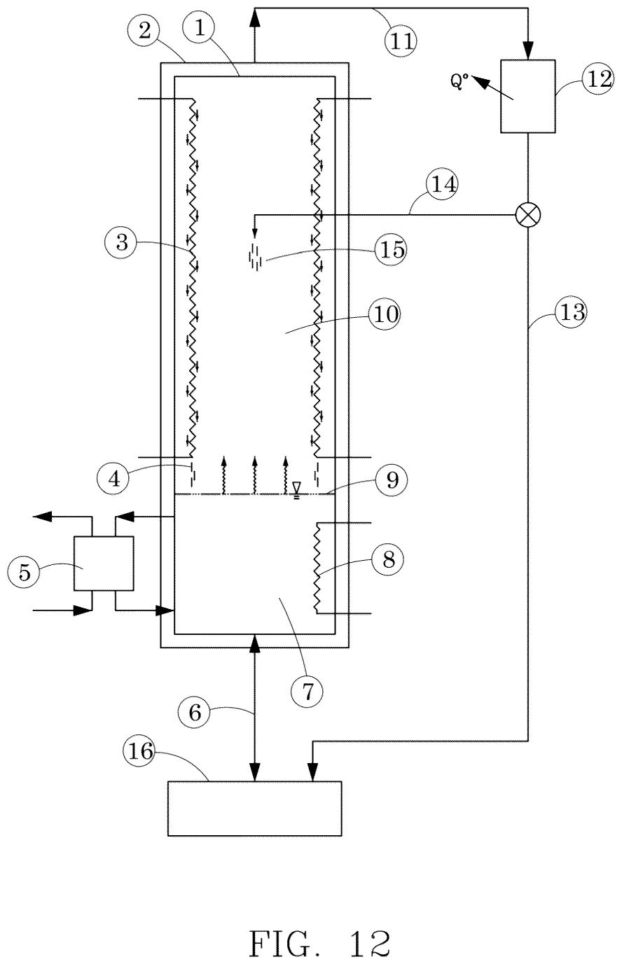

FIG. 12 shows another embodiment of the invention.

A molten fuel boiler nuclear reactor that includes internal condenser 1 is described. Enclosure includes internal volume 1 with neutron reflector 2. Liquid molten nuclear fuel 7 includes fissionable salt. The fuel volume creates reactivity, generating heat, which heats the liquid salt to the boiling temperature of the fissionable salt at the bottom of the reactor, which maintains a volume that supports reactivity. The temperature of liquid 7 is maintained by the boiling temperature of the fissionable nuclear salt by evaporation of excessive mass, which will reduce the molten salt liquid level 9. The top section of the reactor contains molten salt vapor 10 in a gas phase. A heat transfer/condenser 3 is located at the vapor 10. An internal reflector can protect the heat transfer internal flowing element 3 from the radiation (not shown). Some of the vapor is condensed to the liquid molten salt on the condenser 3 and flow 4 down to the bottom molten liquid salt pool, where it will increase the reactivity.

The condenser heat exchanger: When the amount of molten salt generated by vapor 10 exceeds the condensation on condensers 3, the pressure within the reactor 1 enclosure will increase. The pressure increase will increase the boiling temperature of the molten salt 7 and increase the heat transfer and the condensation on the heat exchanger 3, slowing the generation of additional molten salt vapor. The downside of the pressurized reactor is the design challenges, the extra cost, and the operation risk in case of failure, especially given the high operation temperature of the evaporated molten salt. To avoid the high-pressure design and release any potential excessive molten salt gas, reactor vapor 11 flows to condenser 12. The condenser 12 can include an accumulator vapor tank (not shown) to accumulate flow fluctuations and a liquid accumulator (not shown). A portion of the condensed molten fissionable salt fuel 14 is recycled back to the reactor or removed from circulation 13 to a molten fuel tank 16. The reactor reactivity is controlled by the molten salt level 9, where liquid salt 6 can be supplied or removed from the reactor, and the reactor can be drained.

The reactor produces heat for electric production. The heat is recovered from the condenser heat exchanger 3. Additional heat can be recovered directly from the liquid molten salt 7 by internal heat exchanger 8 or external heat exchanger 5 that circulates the molten salt. A substantial amount of heat that can be extracted from the molten salt is the temperature difference between the fissionable salt boiling temperature and the melt temperature as the molten salt is maintained above the melt temperature to prevent freeze and solidification.

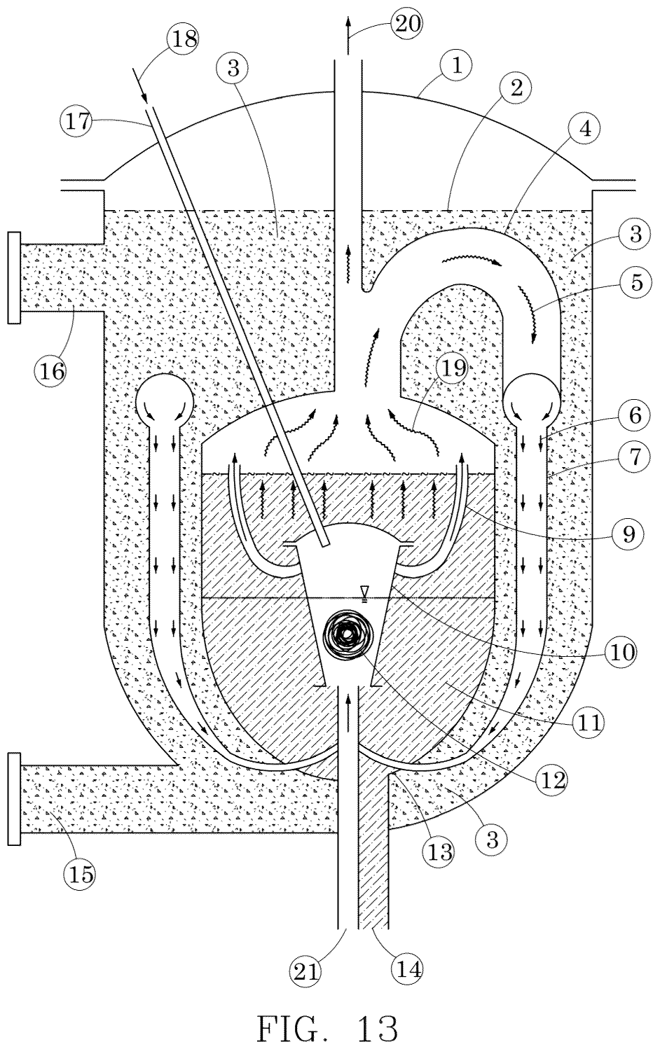

FIG. 13 shows another embodiment of the invention.

A molten boiling fuel nuclear reactor that includes an internal condenser is described. Enclosure includes internal volume 10 with neutron reflector 11. The core center 10 is partly filled with boiling liquid molten nuclear fuel 12, which includes boiling fissionable salt. The reactivity within the core center 12 is mainly temperature dependent and controlled by the fissionable salt boiling to vapor, which reduces the reactivity within the core 12. The boiled vapor salt 19 flows through the reflector medium by conduit 9 and directly through the reflector medium if it includes cavities or is in a liquid phase. The vapor 19 flows 5 to the internal heat exchanger/condenser 7, where it condenses to liquid 6 by heat transfer to heat transfer fluid 3. The condensing fissionable fuel is recycled back into the reactor core 12. Fuel can be added or removed from the core 10 through conduit 21. The reactor core reflector/breeder enclosure 13 and heat exchanger 4,7 are submerged in heat transfer liquid 3.

The liquid can be molten metal containing lead (reflecting neutrons and blocking radiation), molten sodium, or molten salts. The heat transfer liquid 3 is pumped and recycled 15,16 through an external heat exchanger (not shown). Excessive fuel vapor 20 is released from the enclosure, re-condensed, and recycled back to the core to prevent overpressure. Nuclear fuel 18 can be directly fed to reactor 10 through pipe 17. The top fuel feed can be used for the reactor start-up and ongoing operation. Pipe 17 or additional similar pipes allow direct line access to the core center 12 for monitoring, controlling, and potentially isotope production. The reflector volume can include liquid molten salt containing uranium or thorium, solid uranium or thorium oxides, or both. The reflector material produces additional fissionable fuel. The reflector medium, or the flowable portion of the medium, can be accessed for processing, isotope recovery, and purification 14.

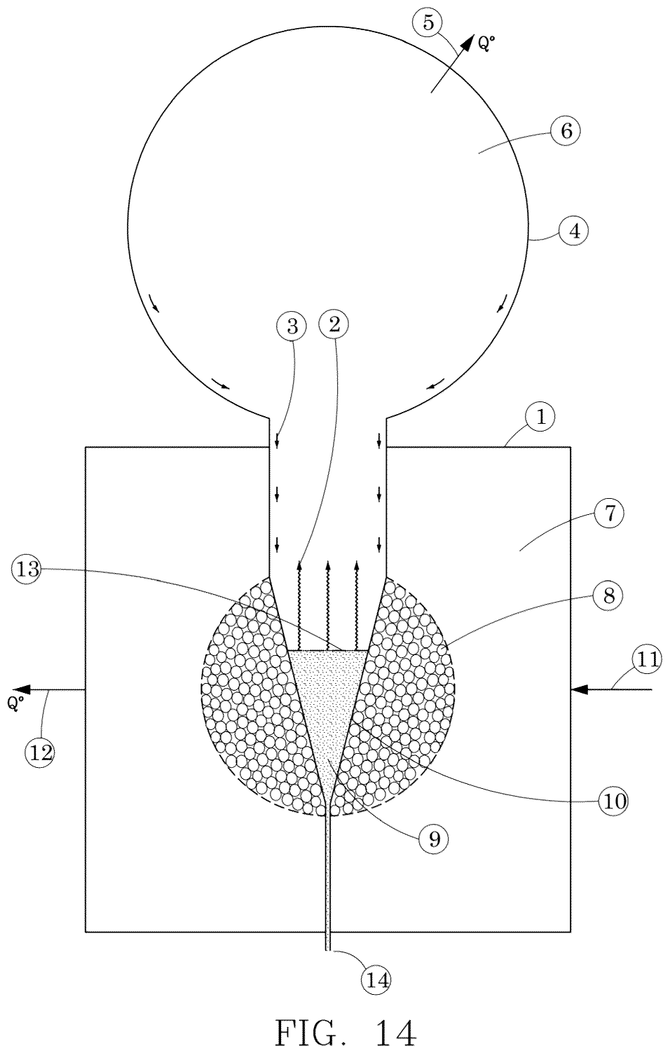

FIG. 14 shows another embodiment of the invention.

A nuclear reactor with a boiling core portion. The core includes a spherical volume 8, which includes solid elements (sphere elements are shown as an example. Any other shapes like cylinders, rings, etc. can be used as well), which include fissionable nuclear material like U235, U233, and plutonium. The reactivity of the spherical elements can be equivalent to 3%-50% enrichment. Solid particles 9 can include fissionable uranium or plutonium oxide that can sustain high temperatures and will not react with the molten coiling fluid salt 7. Metal fissionable uranium or plutonium elements 8 can also be used at lower temperatures as long as they are protected from melting and chemically stable to the cooling medium 7. Volume 10 is located in the center of the reactor core. This volume is partly filled with liquid molten salt 9. The fissionable element 8 reaches criticality when the liquid fissionable molten salt 9 reaches level 13. When the reactor reaches criticality, the heat produced will increase the temperature of the molten salt 9 within reactor void 10. when the molten salt reaches the salt boiling temperature, a portion of the molten salt 9 will boil 2, reducing the reactivity of the core, which will reduce the temperature of the molten salt and allow condensation 3, which will increase the reactivity. The molten salt vapor 6 accumulates in accumulator 4.

Heat 5 is removed from the vapor to condense the vapor back to liquid and increase the reactivity. A portion of the condensed fissionable fuel flows back 3 to the core center to maintain liquid level and reactivity that maintain boiling and evaporation level 13. The overall fissionable fuel capacity is maintained by adding or draining 14. It is also possible to add the liquid fuel from the top 4 portions (not shown). Volume 7 within enclosure 1 includes reflector and heat transfer fluid. The reflector, including T238 or Thorium, can also breed fissionable fuel. There are a few options for volume 7, which include but are not limited to:

Molten lead or lead-bismuth metal can be used as heat transfer fluid 11 and 12 and the neutron reflector. In that arrangement, there will only be fuel breeding within the fissionable liquid salt (as long it includes U238 and thorium) or in the solid fissionable core spherical elements 8.

Molten salts, including molten U238 and thorium salts, will act as heat transfer fluid, reflector, and futile breeding material to breed fissionable fuel.

Liquid metal or molten salts, including light metals (like sodium) that act as a heat transfer medium. For this arrangement, enclosure 1 walls will include heavy walls with heavy elements.

It is also possible to include carbon elements in fluid 1 that will slow the neutrons and allow lower enrichment in core 8. However, this is not preferable as the nuclear focus is on fast reactors that can breed fuel and burn long-lived waste rather than just generate heat, as most of the proven commercial reactors use moderated thermal neutrons.

The reactor core temperature is controlled by the boiling temperature of fissionable molten salt. The reactor is designed to reach reactivity and sport chain reaction when the molten salt 9 liquid level reaches 13. When the level exceeds 13, the reactivity increases, and when it drops, the reactivity decreases. Accordingly, the reactor will be regulated independently from the heat extracted, and accidents will be avoided. Normally, the most severe accident in the reactor is an explosion that includes radioactive vapor release, which includes small particles and core melt-down. The core (or part of it) has already melted in the molten salt reaction. In this invention, during normal operation, not only does the core “meltdown,” but it also boils and evaporates. In other words, the invention is turning the table on the most severe accident scenario (core nuclear fuel evaporation) and “taming” for its use for controlling the reactor in normal operation. The boiling point of nuclear fuel 9 depends on its chemical salt composition and the pressure. By increasing volume 6 volume pressure, the boiling temperature increases. That said, core pressure is a risk factor that requires significant strength in severe temperature and radiation compared to operating at low pressure around atmospheric pressure, which is a crucial incentive to operate at a low pressure (but at high temperature) to maintain thermodynamic efficiency. For fissionable fuel, salt 9 mainly includes U235F4, the temperature will be controlled at about 1400C. If, on the other hand, 9 will include U235Cl4, the temperature will be substantially lower, around 700C. For fissionable fuel 9, which includes high levels of PuF4 and PuCl4, the core temperature will also be influenced by the boiling temperature of these salts. A few fuel salts with different boiling temperatures can also be used (like PuF4 and U235/233F4 salt mixture).

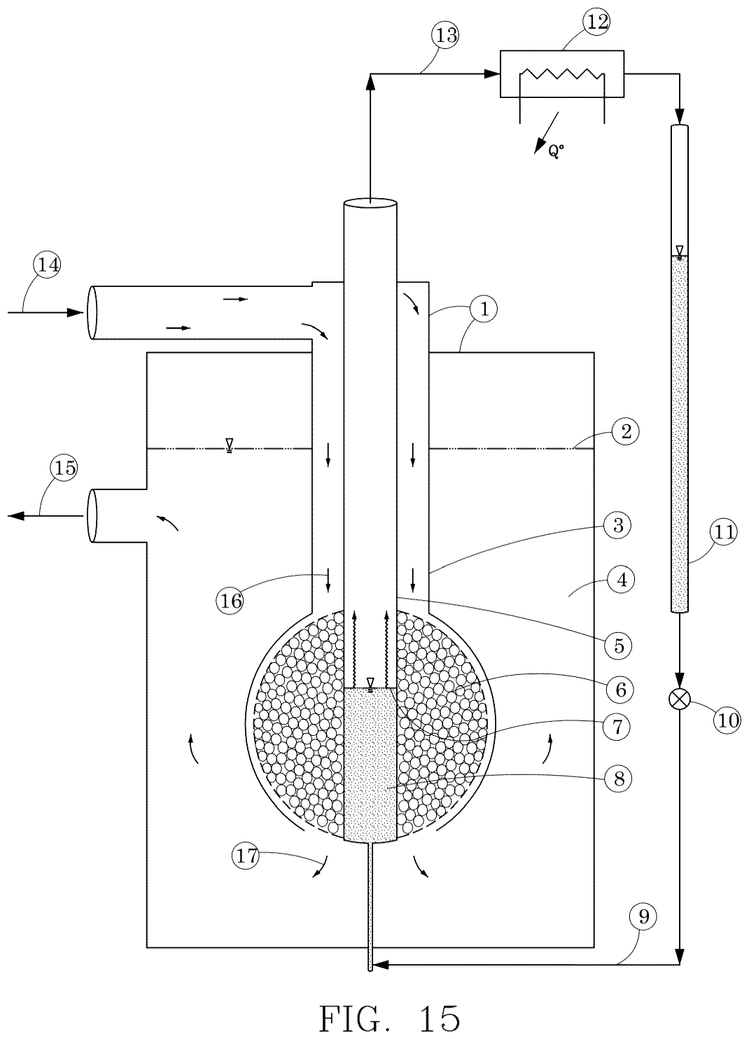

FIG. 15 shows another embodiment of the invention.

A nuclear reactor with a boiling core portion. The core includes a spherical volume 6, which includes solid fissionable nuclear fuel elements (sphere elements are shown as an example. Any other shapes like cylinders, rings, etc. can also be used). The solid elements allow the flow of liquid molten salt through them. They can include uranium 235 and 233 oxide, plutonium oxide, encapsulated metal, or any other solid fuel elements. On the center of the fissionable fuel core 6, there is a void 5. This void is partly filled with additional molten salt fuel, including fissionable uranium, plutonium, and U238. The core becomes reactive when the liquid molten salt reaches a certain level 7. The generated heat boils some of the molten salt fuel 8, transferring it into vapor 13, which reduces the core reactivity. The molten salt nuclear vapor 13 is condensed 12 and accumulated in vessel 11, where through control valve 10, it flows back 9 to the reactor core 8, increasing its reactivity. Heat is recovered from the core particle by flowing fluid 14 directed 13 to the core, where it collects the heat, and flow 15 to an external heat exchanger to recover the heat for electric generation or other processes that require heat. As one example, Molten salt 8 can include U235Cl4 with a boiling point of 791C. The solid spheres 6 can include U23502 and the cooling fluid can also perform as a reflector and breeding and include U238Cl3 in a eutectic mixture with LiCl, MgCl2, NaCl, KCl, and PbCl2.

Another high-temperature example is for the molten salt to include U235F4 with a boiling point of 1417C, which will cause the reactor core temperature to be much higher than the use of U235Cl4. The core particles can also include uranium and plutonium oxide, and the heat exchange fluid 14,15 will also act as a reflector and a breeder, including ThF4, possibly in an eutectic mixture that might include nuclear benign salts like NaF, LiF, KF, and ZnF2.

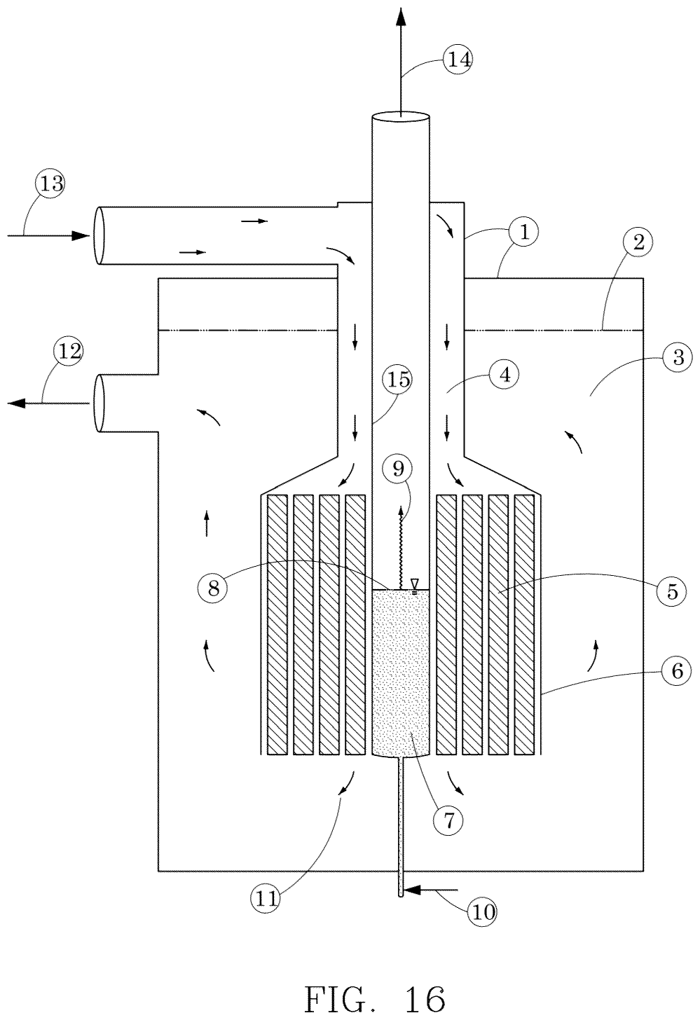

FIG. 16 shows another embodiment of the invention.

A nuclear reactor with an internal boiling core portion is shown. The reactor core includes solid nuclear fuel rods 5 enriched with U235, 233, or plutonium. Heat transfer fluid 13,14 is flowing around the nuclear rods to remove heat. The rods are arranged around a central core enclosure 15, and their reactivity is below the reactivity to sustain a nuclear chain reaction. When the central core volume is partly filled with liquid molten nuclear salt enriched with U235, 233, or plutonium, the core becomes reactive to support the nuclear fission chain reaction. The level of the liquid within core 8 is designed and depends on the core arrangement, the enrichment, the neutron poison contaminates in the core, and the reflectivity and neutron behavior properties of the circulation liquids 12 and 13. The level is designed to maximize the flexibility of reactivity to allow the core to reach reactivity and avoid reactivity in a wide range. As an example, the core should not be reactive.

Support chain reaction where no liquid salt 7 is maintained in volume 15, and on the other hand, the core should be reactive and support chain reaction in any operation scenario (with an increase in the neutron poison contamination as an example) when the fissionable molten salt liquid filling the core. The wider the reactivity zone, the less fuel processing and in-line cleaning like parasitic isotope removal will be required, making the operation more robust, efficient, and safe. Because the fast neutron nuclear generates additional fissionable fuel, over time, the reactor's reactivity might increase, and additional fissionable fuel could be recovered and used as a fuel for “standard” moderated reactors, reducing the need for U235 extraction. This will also create an additional financial incentive and reduce the uranium mining requirements. When the molten liquid salt 7 is heated beyond the boiling temperature due to the core reactivity, a portion will boil 9, reducing the liquid level 8 and decreasing the core reactivity. The fuel salt vapor 14 is condensed, and its heat is recovered and put to valuable use (like electricity generation).

The condensed vapor 10 is recycled to the core liquid internal 7 to maintain its reactivity. The liquid salt 7 can include Plutonium tetra chloride and Uranium tetra chloride with relatively low boiling temperatures to allow the use of more standard nuclear fuel rods 5. Volume 3 is filled with heat transfer liquid. The heat transfer fluid boiling point is higher than the fissionable liquid 7 boiling point to maintain it in the liquid state. The heat transfer fluid 13 can include U238 and thorium and serve as a neutron reflector and fertile breeding material in addition to the heat transfer. The heat transfer fluid 13 is directed to flow around and through the core 6. Another option is to partly fill volume 3 with a solid particle of neutron reflecting and breeding material, like depleted uranium oxide or used thermal nuclear fuel, including burned CANDU, used fuel that doesn't have sufficient plutonium to justify re-processing. The heat transfer fluid can be liquid metal (like lead and sodium) or molten salt eutectic mixture.

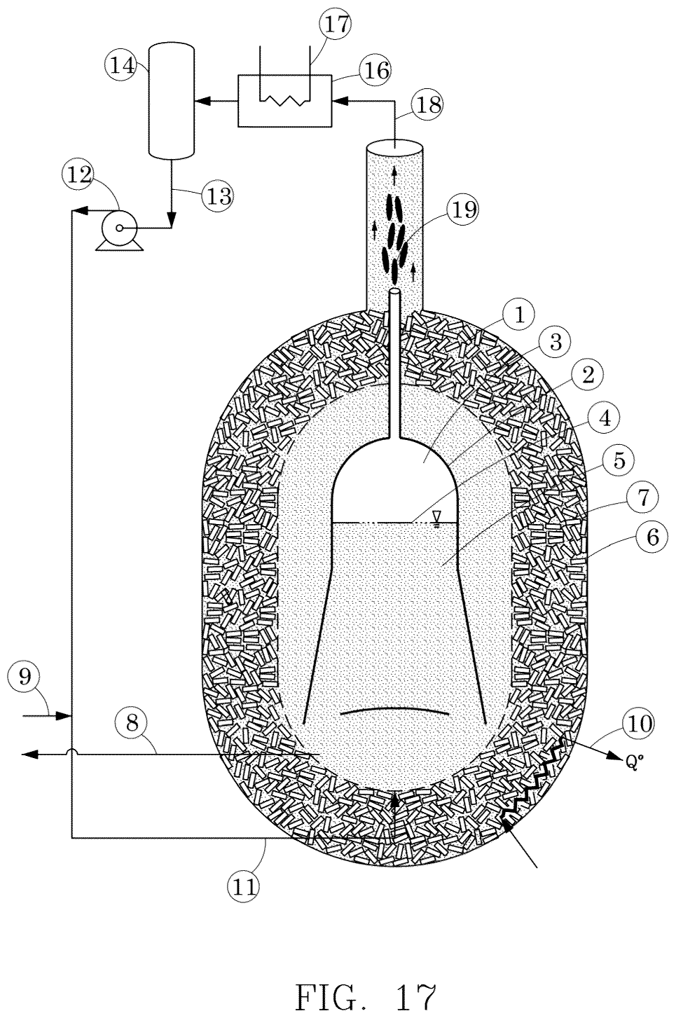

FIG. 17 shows another embodiment of the invention.

A fuel evaporator nuclear reactor 6 includes an internal structure 2, which is open at its bottom and contains an opening in its top 19 that allows vapor 3 to escape from enclosure 2 and flow upwards through molten fuel liquid 5 upwards, generating an up-flow 18. The reactor is elongated, which allows substantial pressure differential due to the specific weight of the liquid and allows for a wider range of reactivity, which is controlled by the fissionable liquid fuel level 4, which can substantially vary within enclosure 2. Liquid level 4 will be low for reactive fissionable fuel 5 with a high percentage of fissionable isotopes and high for fuel with a low percentage of fissionable isotopes.

Enclosure 2 has an opening at its top 19 that allows the generated fuel salt vapor 3 to flow upwards 19 through the liquid molten salt 5 to create a natural circulation. The circulated fuel 18 flows through the process elements described in FIG. 4, with pump 12 as optional. The cold molten salt fuel 11 (kept at a minimum of 50C above the freezing solidification point) circulates back to the reactor. Fissionable-rich fuel 8 can be removed from the reactor and replaced 9 with non-fissile fuel that can include processed spent nuclear fuel destined for disposal. The reactor core is surrounded by a reflector and breeding layer 1. The layer can include spent fuel or re-processed fuel uranium oxide 7 with the molten salt free to flow through the reflector layer. Additional heat can be removed from the reactor through an internal heat exchanger 10. The reflector breedable layer 1 is separated from the core internal volume by a perforated structure that can withstand intense heat and radiation without requiring a good heat transfer and maintaining seal and pressure. This allows using ceramic materials like zirconium oxide, alumina, zirconium carbide, tungsten carbide, and other ceramics.

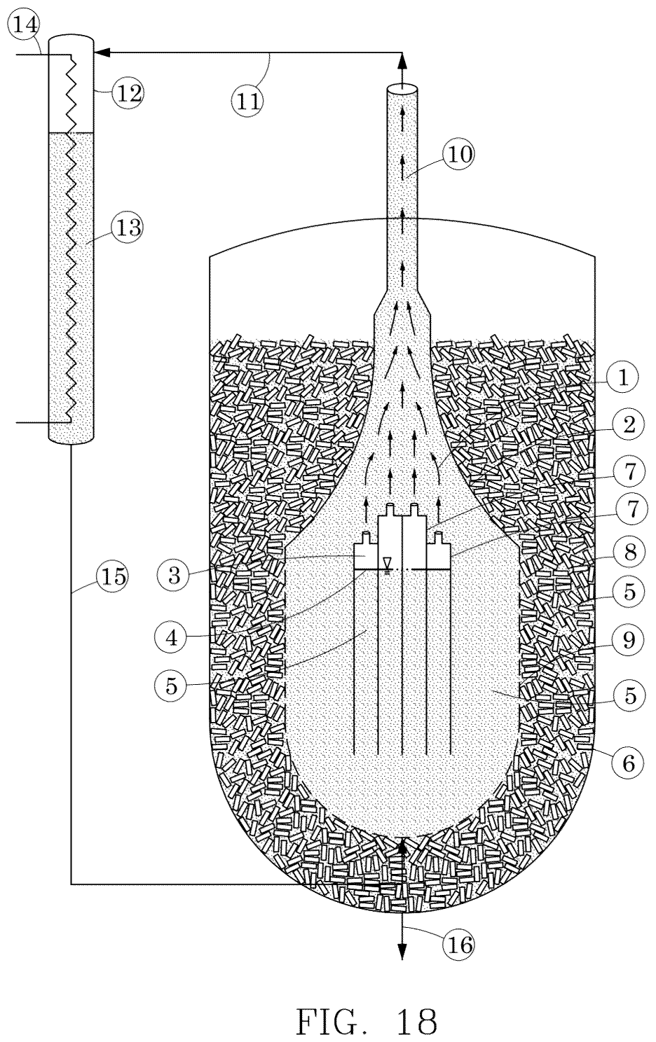

FIG. 18 shows another embodiment of the invention.

A fuel evaporator nuclear reactor 6 includes an internal structure for holding fuel salt vapor. The internal structure is composed of multiple longitude enclosures 7. The enclosures can be cylindrical or hexagonal, open at the bottom, and sealed at the top with vapor release openings at the top. The liquid salt fissionable fuel is evaporated 3 and trapped in the elongated enclosures, preventing the liquid fuel from filling the enclosure and exceeding the desired criticality based on the core temperature and the fuel boiling point. Using a smaller longitude structure might be advantageous because the other elements will still control the reactivity even with few cylinders or hexagonal failure. Another advantage is that the strength of smaller enclosures is greater, and it allows for the use of a smaller wall thickness. It is also easier to fabricate such elements, especially if they are made from ceramic material like zirconium-based ceramics. The up-flow vapor gas 10 generates an up-flow of the molten salt 11.

The molten salt, possibly with a vapor phase, flows to an accumulator, condenser, and heat exchanger 13 where separate working fluid 14 is recovering heat for energy generation or any other need. The accumulator 13 is sub-critical in any scenario by design. The molten salt 15, after the heat has been recovered, is recycled back into the reactor. The reactor can be drained 16 for shut-down or removal of solids generated from the reflector breeder 6 over time. The packing filling of the reflector/breeder can be spent fuel, including CANDU spent fuel.

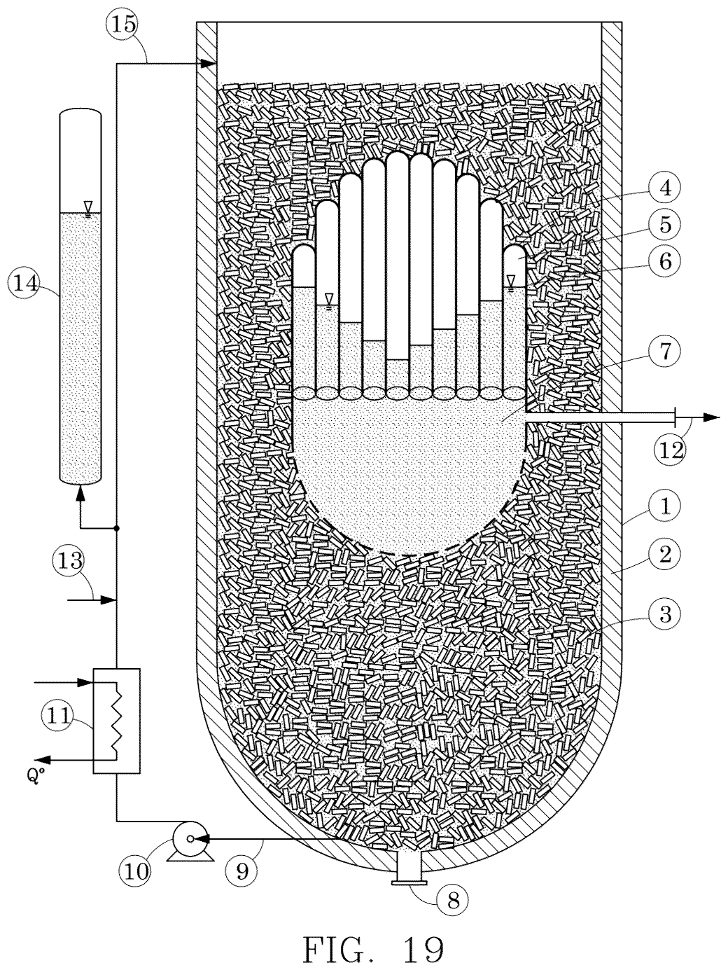

FIG. 19 shows another embodiment of the invention.

Reactor 1 includes an internal sealed enclosure 4 in its core. The enclosures are open at their bottom, allowing molten salt liquid nuclear fuel with fissionable isotopes 7 to flow in and out of the vertical enclosures. The enclosure can be cylindrical, hexagonal, or any other engineered shape that can be effectively manufactured from the enclosure wall material. The enclosure material should stand the molten salt chemical, the heat, and the intense radiation. Ceramic materials, including zirconium oxide ceramic, can be considered as having a poor heat transfer coefficient, which is not a critical factor for this application, the same way it is in standard nuclear rods that must transfer the heat from the solid fuel to the cooling surrounding. Each enclosure can hold molten salt vapor 5 at its top section and push the fissionable liquid fuel level 6 down, reducing the core activity. The core internal temperature will be based on the fuel 7 used—if UF4 is used, the core temperature will be controlled by the boiling temperature of this fuel. The same applies to using UCl3 or UCl4, where the core temperature will be the lowest for the UCl4 according to its boiling temperature. The core center is surrounded by reflector 3, which includes non-fissile solids, allowing the molten salt liquid fuel to flow through. For the surrounding elements, 3 U238O2 and thorium oxide can be used.

A preferred option would be to use spent fuel waste nuclear material before or after re-processing, as explained in the other figures' description. Nuclear fuel 7 can be removed from the core for re-processing or commissioning a similar nuclear salt reactor. New molten salt fuel 13 can be added to replace the removed fuel 15. The new molten salt 13 can include non-fissile isotopes, including re-processes spent fuel rejects after most valuable isotopes (mainly plutonium) were recovered. The long-lived actinides radioactive isotopes within fuel 15 will be “burned” by the intense fast neutron bombardment in the core. Molten salt surrounding core 9 is circulated through pump 10 and heat exchanger 11 to generate heat and energy. The overall reactor molten salt fuel level is maintained by sub-critical accumulator vessel 14. The molten salt fuel is recycled back to the reactor 15. The reactor is surrounded by an additional layer of passive neutron reflector and radiation barrier (like lead and Tungsten) and a layer of radiation and neutron barrier (like boron base materials, water, etc.′).

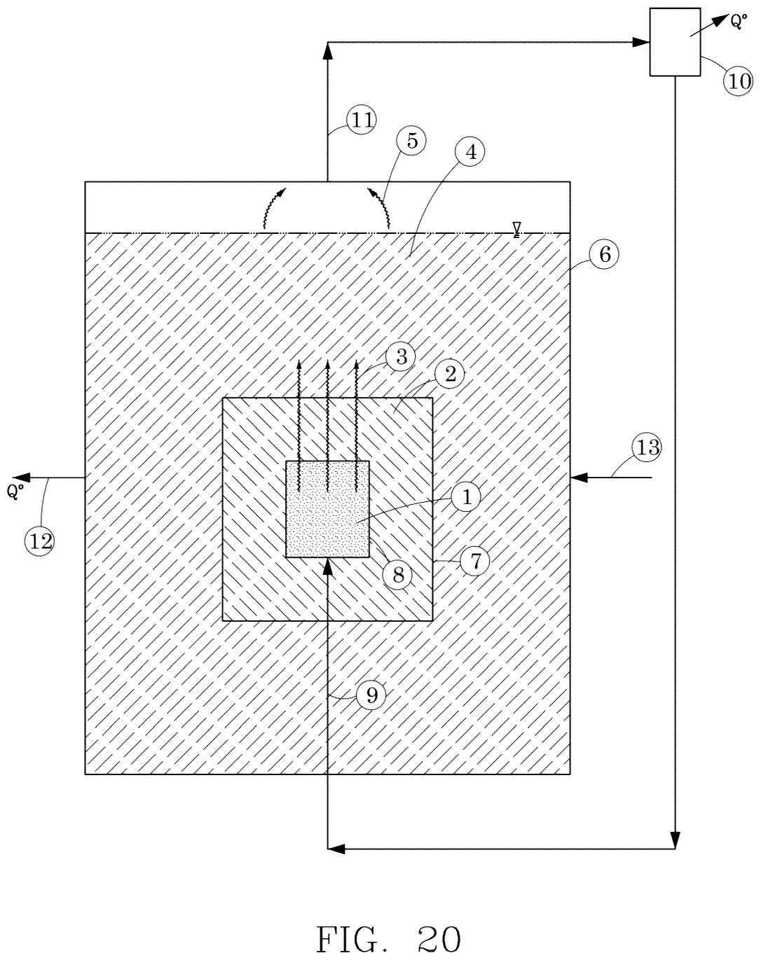

FIG. 20 shows another embodiment of the invention.

A nuclear reactor with an internal boiling core portion is shown. The reactor core includes volume 7, which includes fissionable solid nuclear fuel elements that include U235, 233, and plutonium 2. The elements can be arranged as packing fill (spherical, cylindrical, blocks, or any other arrangement). In volume 7, there is an additional Volume 8 partly filled 1 with liquid nuclear fissionable molten salt fuel 9. Volume 7 becomes nuclear reactive only when the amount of liquid molten salt 9 reaches a certain level. At that point, the heat generated at volume 1 boils a portion of the salt, changing the liquid phase to a gas phase 3.

The gas phase bubbles reduce the amount of the fissionable molten salt fuel within volume 1 and bubbles out through the surrounding solid fuel, leaving volume 7 and into the surrounding heat transfer liquid 4. Before liquid 4 reaches the boiling temperature of fissionable liquid salt fuel 9, vapor 3 will condense into liquid 4, increasing its reactivity. When the liquid 4 reaches the fissionable salt 9 boiling temperature, a portion of molten salt 9 will boil 5 and evaporate out of liquid 4. The evaporated fissionable fuel 11 is condensed in condenser 10 while recovering the condensation heat Q and recycled back 9 to reactor core 8. The reactor volume surrounding the core 4 includes a reflector. The reflector can be a solid or liquid reflector. The solid reflector can include solid uranium oxide packing, rods, or any other structure that allows the flow of liquid 13 throughout volumes 4 and 7. Used fuel can also be a reflector as long the core reactivity compensates for the parasitic neutron poison within the thermal (moderated) used fuel. The uranium neutron reflector also breeds additional fissionable plutonium fuel. The breeding of additional fuel can occur throughout the reactor, starting from within core 1, where liquid U238 within fuel 9 breeds plutonium, and in volume 2, where additional U238 within the U235, 233, and plutonium breeds additional plutonium. In addition to the solid neutron reflector, liquid flow 13 and 12 can include molten uranium 238 and thorium salts that work as reflectors and breed additional fuel.

Because of the direct contact between enriched fissionable fuel 9 and the blanket molten salt 4,12, 13 there will be fissionable enriched fuel within the surrounding molten salt; however, fissionable uranium fuel 9 salt chemical composition is different from the chemical composition of the non-fissionable U238 salt composition 4 which have a higher boiling point (like, as an example, U235Cl4 (mostly in flow 9 and 11) Vs. U238Cl3 (mostly in blanket 4, flow 12 and 13) boiling points and U235F4/PuF4 (mostly in flow 9 and 11) Vs. ThF4 boiling point (mostly in blanket 4, flow 12 and 13)) The generated heat in the core (except the condensate heat 10) is carried by the molten salt 13 flow. To reduce the molten salt 13 melting point, additional nuclear non-active salts can be added, like NaF, NaCl, etc. The molten salt 13 boiling point is higher than the fissionable fuel 1 boiling point 3. As an example, if the fuel includes U235F4, the cooling/reflecting breeding flow 13, 12 can include U238F3 or ThF4 with additional salts like NaF, KF, LiF, etc.′ with a boiling point higher than the U235F4 boiling point. When the reactor reaches the boiling point of the uranium tetrafluoride, it will evaporate 5, 11, and be condensed in condenser 10 and recycled back to reactor 9.

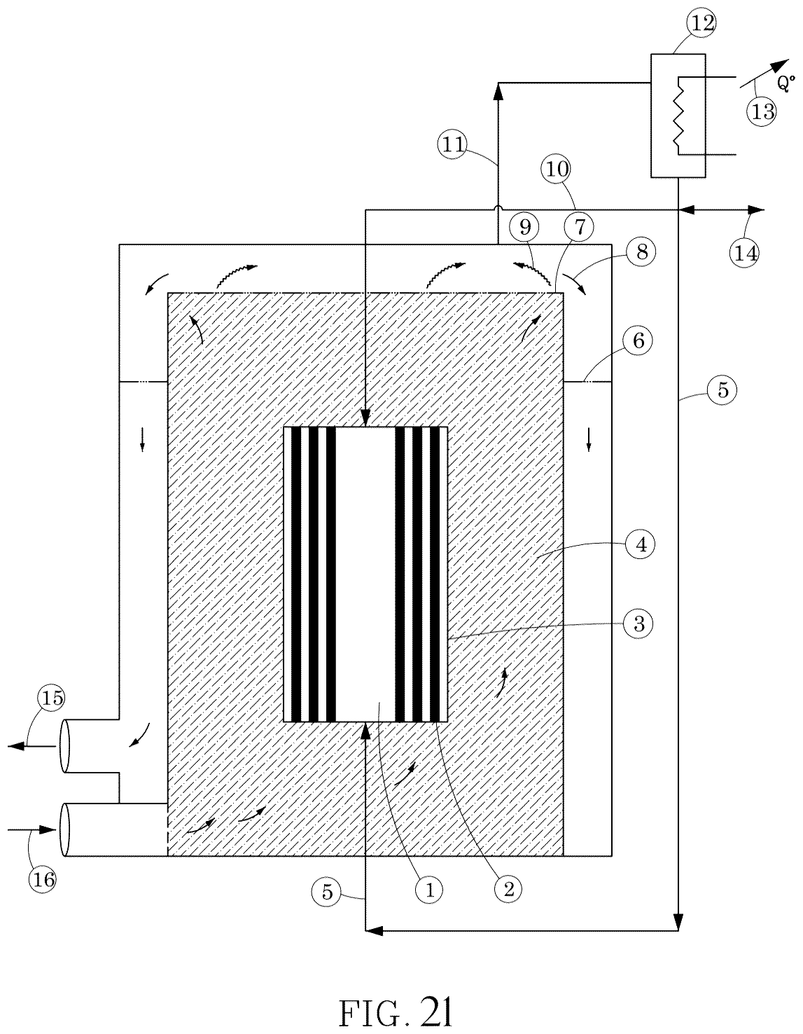

FIG. 21 shows another embodiment of the invention.

A nuclear reactor with an internal boiling core with solid nuclear rods is shown. The reactor core includes volume 3, which includes fissionable solid nuclear fuel element rods containing U235, 233, or plutonium 2. The core becomes reactive, and then 1 is partly filled with liquid fissionable nuclear fuel containing fissionable uranium and plutonium 5,10. The core is surrounded by a volume 4 blanket that can contain solid neutron reflectors like U238 oxide and thorium oxide, which also breeds fissionable fuel in addition to the neutron reflection. Nuclear spent fuel can also be used, including CANDU fuel spent fuel waste, which burns most of the useful fissionable fuel, so its waste is not useful for Pu extraction re-processing. If used fuel is used, the core 3 and 1 reactivity will have to be higher to compensate for the neutron that the parasitic poison will consume contaminates within the used fuel; however, because the wide range of the core reactivity due to the flexibility in the potential molten liquid fissionable salt 5, 9 within the core, this can be overcome without the need for re-processing. Also, because the used fuel contaminates were created by a slow moderated nuclear reactor, they might be less harmful when exposed to the fast neutron reactor, which might burn them into other isotopes while generating heat, the reactor's most useful product.

The core 7 center volume 1 can be fed fissionable liquid salt from the top 10 or the bottom 5. The fissionable liquid salt boils when the core reaches the boiling temperature, and the vapor bubbles produce reduced reactivity. The fissionable fuel vapors 11 evaporate from the reactor liquid surface 9 and are directed to condenser 12 where heat 13 is recovered and the vapor condensed back to fluid, which can be recycled back to the process 5, 10 or directed to a reservoir and back 14 to control the reactor. Molten salt that might include U238 and thorium flow through the reactor fissionable solid fuel rods 2 in volume 3 and through the surrounding reflector blanket volume 4. Molten salt heat transfer fluid 16 17 is pumped through the reactor. The boiling temperature of the heat transfer molten salt is higher than the boiling temperature of the fissionable nuclear fuel 5, 10. The molten salt 16 carried the boiling fissionable fuel where the bubbles and vapor phase were separated from the liquid 7. The liquid is overflowing to level 6 to minimize the carry-on gas phase in the liquid phase 15, leaving it to an external heat exchanger (not shown) where the heat is recovered and used for high-pressure steam for electric energy production or any other use.

The reactor operation temperature mainly depends on the fissionable fuel component evaporation temperature. For example, if U23514 is used as the fissionable fuel, the core temperature will be relatively low as the boiling temperature of the uranium tetraiodide is around 760C. The heat transfer fluid can also be a neutron reflector and futile readable and includes U23813 or Thl4 with Lil, Nal, Kl, Mgl2, etc.

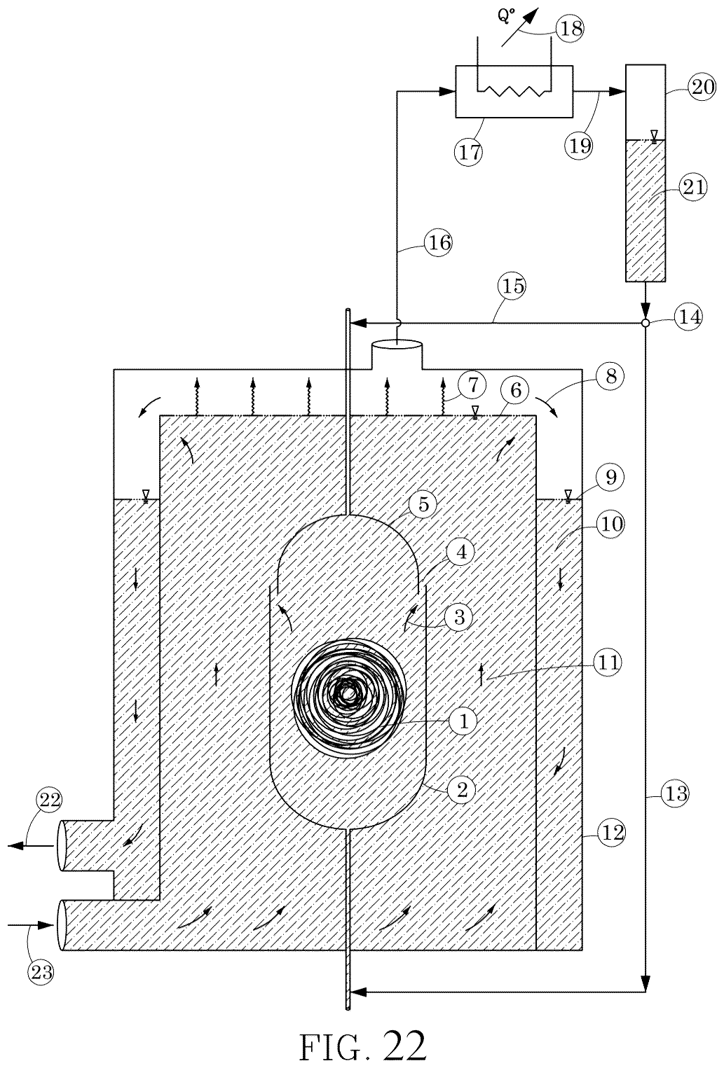

FIG. 22 shows another embodiment of the invention.

A nuclear reactor with an internal boiling core is shown. The reactor core includes a partial enclosure 2, 5. The enclosure is partly open 4 to the surrounding volume 11. Fissionable liquid molten salt nuclear fuel 13, 15 flows into reactor 2. When the reactor volume is partly filled with the fissionable fuel, core 1 becomes reactive, supporting the nuclear fission chain reaction. The heat causes some fuel to boil and bubble, reducing the reactivity. The fission fuel vapor bubbles and excessive liquid left enclosure 3 and flowed upward through the surrounding liquid blanket 11. If the temperature of the molten salt liquid in the surrounding volume 11 is lower than the fission fuel boiling temperature, the vapor will be condensed into the liquid 11, increasing the overall reactor volume reactivity until the reactivity is sufficient to increase the temperature to at least the boiling fission fuel temperature (and beyond due to the delay fission within the fuel when it becomes reactive). When the surrounding core molten salt fluid reaches the boiling temperature, the fissionable molten fuel salt will boil from the liquid surface 6 and leave the liquid in a vapor form 7. The vapor 16 flows to condenser 17, where the condensation heat 18 is recovered, and the liquid fissionable salt 19 accumulates 21 in accumulator 20.

The condenser and the accumulator are designed to avoid criticality by proper physical dimensions and using structural materials that include bore, cadmium, hafnium, etc. The condensed nuclear fissionable fuel liquid molten salt is supplied in a controlled manner 14 back to the reactor bottom 13 or top 15. For the reactor start-up, there is an advantage to supplying the reactive molten salt from the top to minimize the pre-heat requirements, especially for the large volume of heat transfer, reflector, and breeder surrounding blanket 11. The surrounding molten salt 11 also reflects neutrons and breeds additional fissionable fuel. It can include U238 and thorium salts and additional non-nuclear reactive salts to reduce the melting point of the salt mixture and improve the heat transfer properties, possibly in an eutectic mixture or close to it. The boiling point of the U238, Thorium, and the other surrounding salt mixture is higher than that of the fissionable fuel. For example, if the fissionable fuel is 30% U235 enriched fuel, then if uranium tetra chloride fuel salt is used, the boiling fissionable fuel will include 30% U235C14 and 70% U238Cl4. In that case, the surrounding volume of reflector, breeder, and heat transfer 11 might include additional U238 but at a different salt chemical composition that boils higher than the uranium tetra chloride. For example, U238Cl3 and U238F4 can be used as their boiling point is higher. The other nuclear non-reactive salts will also have a higher boiling point (like LiCl, LiF, NaCl, NaF, etc.′) with the melting point of the salt mixture (preferably eutectic mixture) lower than the boiling point of the uranium tetra chloride.

The surrounding molten salt 11 can overflow 6 over edge 8, where the vapor bubbles are released and cycled through a heat exchanger (not shown), where heat is recovered for steam generation and electric energy production. The temperature potential for heat recovery is the difference between the molten point of flow 22, 23, and the boiling point of the fissionable fuel 21. To avoid the freezing risk, fluid 23 should be kept at 50C above the melt temperature. For example, with the use of U235Cl4, the boiling temperature will be close to 800C, and if the salt mixture minimum working temperature is 650C, this allows very substantial heat recovery potential from the recycled fluid 22, 23 which, combined with the high temperature will allow an efficient heat energy conversion to electricity.

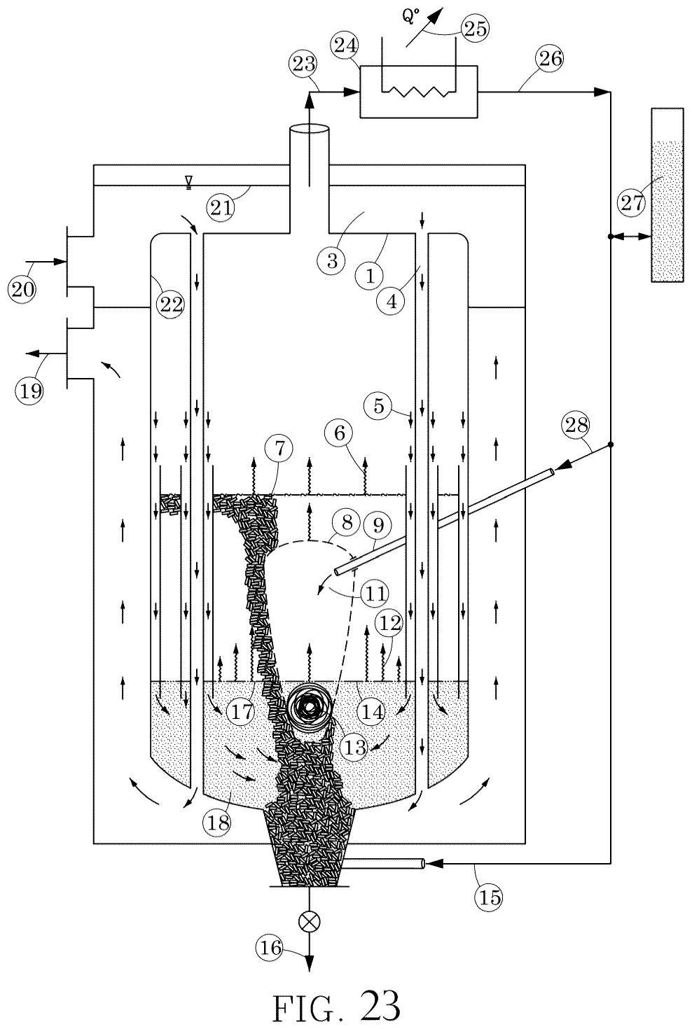

FIG. 23 shows another embodiment of the invention.

A nuclear reactor with an internal boiling core and internal heat exchanger is shown. The reactor internal enclosure 1 is partly filled 7 with solid particles of U238O2 (or ThO2). The solid particles can be cylindrical or spherical elements 7. Spent nuclear fuel, including CANDU waste fuel, can also be used. The solid particles can include parasitic isotopes as the fast neutron reactor will naturally adjust its reactivity to compensate for poisons and “burn” the radioactive Actinides while producing useful heat. The solid U238O2 pellets are neutron reflectors. They also reduce the reactivity of the reactor as they reduce the volume for the reactive fissionable liquid molten salt, which fills the voids between the pellets below the filling level 17. The solid U238O2 also protects the reactor's internal heat exchanger/condenser from intense radiation and core heat due to their superb heat resistance and neutron reflection.

Molten salt fissionable nuclear fuel 28, 15 flows into the reactor. The molten fuel fills the reactor bottom up to level 17, where at this level, the reactor reactivity within the center volume 8 generates sufficient heat to heat the fuel to its boiling point and evaporate 12, 6 excessive liquid fuel. For example, if the liquid fuel includes enriched uranium tetrafluoride, the boiling temperature will be around 1420C, which will also be the vapor 6, 23 temperature.

To prevent solidification, the condensed enriched uranium tetrafluoride liquid will be kept at a minimum temperature of 1090C (about 50C above the melting point). One option to reduce the melting point and reactivity of the enriched UF4 is to add KCl and NaCl salts. These salts will reduce the melting point, boil, and evaporate with the UF4. For such a salts mixture, the condensed enriched uranium tetrafluoride, potassium chloride, and sodium chloride molten salt liquid will be kept at a minimum temperature of about 50C above the melting point, which will be substantially lower than the minimum temperature of 1090 required for only the UF4 salt.

Volume 11 is located at the center of the reactor core to generate and maintain the reactivity. The reactivity in volume 11 is higher than its surroundings as it is not filled with the U238O2 solid elements. Hence, the concentration of the fissionable fuel within the liquid salt is higher within volume 11. The internal molten salt fluid within volume 11 directly interacts with its surrounding liquid salt 18, salt vapor 12, and the UO2 aggregate fill 7. Volume 11 is maintained by Structure 8. Structure 8's material requirement is to withstand the molten salt chemicals, the intense radiation, and the high temperature.

In contrast to “normal” fuel cladding, it does not have to have high heat transfer as the internal volume 11 and its surrounding area are in direct contact. This will provide more flexibility in material selection and can allow longer life for enclosure 8 before it has to be replaced. For example, Zirconia ceramic (zirconium oxide), which has good temperature and chemical stability but poor heat transfer properties, can be considered for enclosure 8. Furthermore, as it doesn't have to maintain pressure or prevent direct contact between internal volume 11 and its surroundings, a high level of degradation in the 8 structures can be tolerated before it has to be replaced. Furthermore, even in the catastrophic failure of internal structure 8, the UO2 surrounding aggregate will fill or partly fill volume 11, reducing the core reactivity with no external contamination risk.

As previously explained, this boiling core reactor invention is inherently safe as the “core fuel meltdown” followed by the “core fuel evaporation,” which are catastrophic accidents in a “normal reactor,” are part of the normal operation of the proposed reactor like “taming the dragon” so to speak. Fissionable fuel 26, 27 is supplied 28 to the reactor internal volume 11, especially during start-up. The fissionable fuel can also be supplied from the bottom of the reactor to maintain and control its reactivity.

At a certain liquid level 17, the reactor reactivity will generate heat to heat the reactor to the temperature where the fissionable nuclear salt is boiled. The boiled vapor 12 flows through the UO2 aggregates 7 and into the top reactor volume 6. The reactor is “submerged” in heat recovery fluid. The heat recovery fluid can be molten salt or molten metal. 3. Molten aluminum can be used for a high-temperature reactor (Fissionable UF4) with high effective heat transfer efficiency and low neutron interaction but with a high melting point. Another option is to use molten lead (possibly but not necessarily with Bismuth), which will also perform as a neutron reflector and radiation shield.

The lead boiling point is higher than the fissionable fuel boiling point, so it will not boil even if, due to an incident, there will be a sudden stop at the cooling molten lead circulation with no heat recovery; the temperature will reach the nuclear dispersing fuel boil temperature while the reactivity will sharply fall due to liquid fuel mass reduction. The ongoing radioactive decay heat will continue to evaporate the molten salt until it reaches a passive thermal steady state between the decay heat and the normal high-temperature reactor passive heat loss.

Evaporated fissionable fuel salt is condensed internally on the cooled enclosure walls 22, 1. To increase the heat recovery, the reactor can include internal pipes 4 that exchange heat between the liquid 19,20, the vapor 6, and the liquid below the liquid level 17. Vapor is condensed back to liquid 5 and flows down to increase the reactivity and the ongoing salt boiling. To increase the condensation and to allow the liquid to directly reach the liquid level 17 without having to flow through the aggregate through the up-flowing salt vapor, additional pipes 10, possibly perforated, can be added with a gap to keep a vapor-filled space between the aggregates and the vertical heat exchanging pipes 4. To avoid over-pressure of the reactor enclosure 1, any excessive fuel vapor 23 is released and condensed in condenser 24, which recovers the condensation heat 25. The condensed liquid molten salt 26 can be stored in accumulating enclosure 27 or recycled back to the reactor, where it can be fed from the top 28 directly to the core center 9 or to the bottom 15, where it is added to the liquid molten fissionable salt. During start-up, the fuel is fed directly to the core center 9.

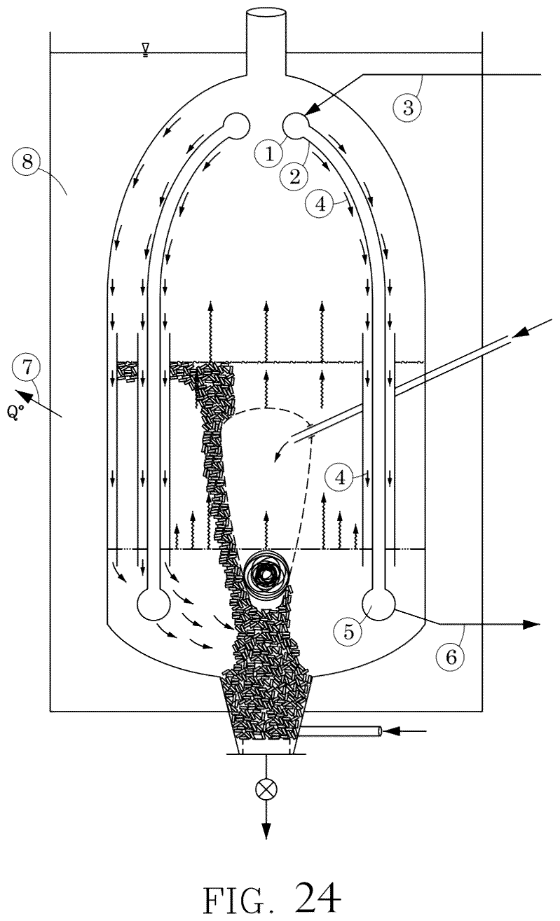

FIG. 24 shows another embodiment of the invention.

A nuclear reactor with an internal boiling core and internal heat exchanger is shown. The reactor is substantially identical to FIG. 16 but has a separated heat exchanger/condenser inside the enclosure. The reactor is surrounded by liquid volume 8, which recovers heat 7 that flows through the reactor's external enclosure. The internal heat exchanger circulates liquid heat transfer fluid 3,6. The fluid can be liquid metal like sodium, lead, or lead-bismuth. Molten salt can be used as well. The liquid is flowing between header 1 and footer 5. The header and footer are connected with branches pipe 2, where the heat exchange liquid flows between the header distributor and the footer collector 5. Fissionable fuel salt vapor condenses on the internal heat exchanger pipe and flows by gravitation back to the reactor bottom, increasing the reactor reactivity. The recovered heat from the circulation flow 6 generates steam and electricity.

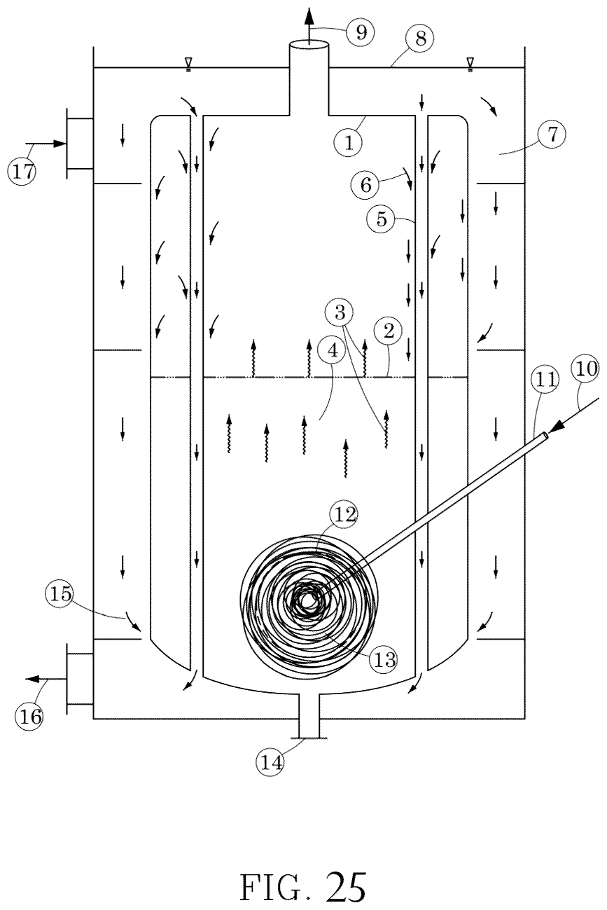

FIG. 25 shows another embodiment of the invention.

A nuclear reactor with an internal boiling core and internal heat exchanger is shown. The reactor internal enclosure 1 is partly filled 4 with molten salt, including U238 or Th. The molten salt can include additional non-active nuclear salts of Li, Na, K, and Mg that reduce the melting point and the reactivity. The molten U238 salt acts as a neutron reflector and breeds additional fissionable Pu fuel. If Th salt is used, it will breed fissionable U fuel. Fissionable fuel is fed 10 through pipe 11 into the area of liquid 4 center of mass.

A structure 12 that restricts the liquid flow within liquid volume 4 can maintain the substantial mass of the fissionable molten salt fuel at the center of the reactor, surrounded by the blanket of the reflector and breeding non-fissionable Uranium 238 or thorium. There is direct contact and a mixture of the fissionable fuel 13 and the surrounding blanket of molten salt 4. The reactivity generates heat that heats volume 4, including volume 13, in its center to the boiling temperature of a portion of the fissionable fuel 10. For example, if U235F4 and PuF4 salt are used, the temperature will increase to boiling. It is possible to use a combination of fissionable fuels with different boiling temperatures (Like U235F4, U235Cl4, PuF4, and U235Cl3), where in that fuel, the UCl4 will boil first as it boils below 800C. If the reactivity is still high, its boiling will be followed by the next lowest boiling point, and so on. The UCl3 will boil the last, but if the reactivity is sufficiently reduced by the boiling of the other fissionable fuel salt, it will not boil and stay in the liquid blanket 4, thus increasing the reactivity and allowing the lower amount of fuel 10 to reach and maintain the reactor reactivity.

The fissionable fuel, as well as other salts with similar boiling points (for example, if the fuel is composed of 30% enriched uranium fluoride, both the 30% fissionable U235F4 and the 70% U238F4 will evaporate 3 and change to a vapor at the boiling temperature. The surrounding reflector and breeding blanket include additional non-fissionable salts with higher boiling temperatures, like U238F3, U238Cl3, ThF3, etc.′ with higher evaporation points to maintain them in the liquid form. The liquid salt can also include fissionable fuel with a higher boiling point than the fissionable fuel 10, like U233Cl3, U235Cl3, U235F3, PuF3, and PuCl3. This fissionable fuel will increase the reactor reactivity but is not used to maintain the maximum temperature maintained by boiling fuel 10. Different combinations of fissionable salts and blanket salts will result in different reactor temperatures—as an example if most of the fissionable fuel salt 10 will be U235Cl4 or PuCl4 and the blanket salt will include U238F4 or U238Cl3, as well as other eutectic salts like LiCl, LiF, NaF, NaCl etc.′, the reactor temperature will be lower as it will be related to the lower boiling temperature of the U235Cl4 or PuCl4. Heat is recovered from the reactor through heat exchanger 5 and from the reactor structure enclosure 1.

The heat is recovered by liquid heat transfer circulation medium16, 17, which flows around the reactor enclosure 7,15 and through a heat exchanger 5 inside the enclosure volume to enhance the heat recovery and the vapor fissionable molten salt fuel condensation 6. The condensed fissionable for the heat exchange liquid 16,17 molten metal can be used like molten lead and bismuth. Molten high-temperature heat exchanger eutectic salt mixture can be used as well.

Each heat transfer material will have advantages and disadvantages, impacting the structure reactor heat exchanging surface material selection. For example, a molten lead will also reflect neutrons and block radiation but with a different corrosion-resistant material selection than the molten salts, including lead salt compositions like PbF2, PbCl2, and PbO. Excessive vapors 9 that did not condense 6 internally on the reactor enclosure 1 and heat-exchanging elements 5 are released from the reactor and condensed to liquid externally (not shown). Some condensed liquid salt fuel, possibly with additional fuel from an external molten fuel container, is recycled back into the reactor to maintain its reactivity.

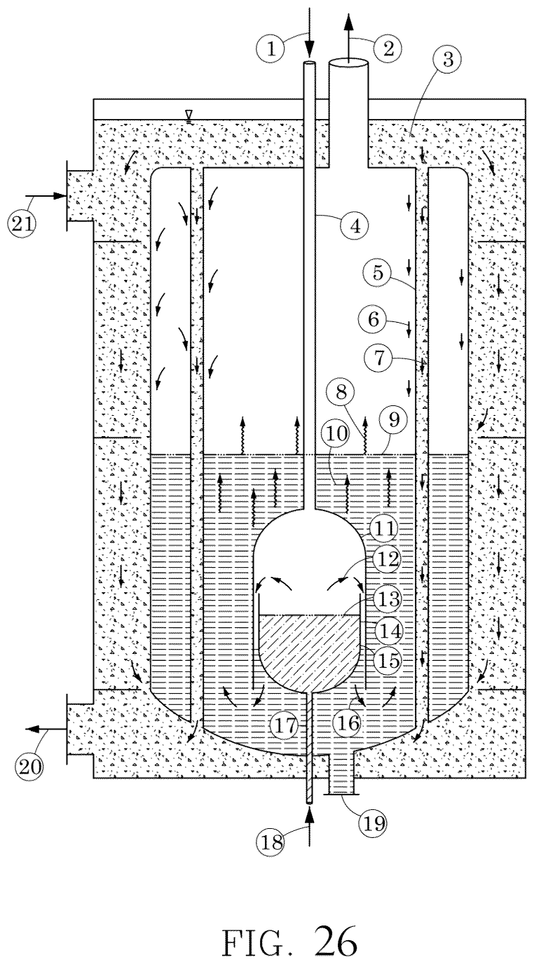

FIG. 26 shows another embodiment of the invention.

A nuclear reactor with an internal partly enclosed boiling core and internal heat exchanger is shown. The reactor's internal enclosure is partly filled with 10 molten salts, including U238 or Th. The molten salt can include additional non-active nuclear salts like Li, Na, K, and Mg that reduce the melting point and the reactivity. The reactor core includes a partly enclosed core of 11 14. The core enclosure includes two parts, top 11 and bottom 14. Fluid 12 can flow through the gap 15 between the core enclosure and the surrounding breeding, and neutron reflecting and heat dispensing blanket molten salt 10. Molten liquid fissionable salt 18 is fed to the core internal enclosure. The fuel reaches reactivity and is partly boiled.

The fuel can include a mixture of fissionable salts with different boiling temperatures to control the reactivity steps of evaporation, where a portion of the fissionable fuel boils at one temperature, reducing the reactivity, while the other portion boils at a different higher temperature, further reducing the reactivity to maintain the core maximum temperature. For example, a mixture of U235/233Cl4 and U235/233F4 can be used, where the UCl4 boils at around 800C, and the UF4 boils at around 1400C. Another option is to use U235/233Cl4 and U235/233Cl3, which boils around 1700C. Another example is to use U235/233F4 and PuF4. Another example is to use U235/233Cl4 and PuCl4. Mixing 3 or more fissionable fuel salts with different boiling temperatures is also possible. For example, U235/233F4, PuF4, U235/233Cl3 and PuCl3 mixture. Another example is U235/23314, PuI4, U235/23313 and PuI3 mixture. The cote center enclosure is accessible from the top through conduit 4, where fissionable fuel 1 can also be fed from the top, especially during the reactor start-up. It is also possible to purge the internal enclosure before maintenance with pressurized gas that can be fed instead of fuel 1 through conduit 4, push the internal liquid 13 out to an external fuel drain container through 17, and prevent liquid 10 from filling the internal core enclosure back-flowing through gap 15 and possible throughout 17 so preventing the blanket breathable/reflector from mixing with the liquid drained fissionable salt or freezing inside the core enclosure 11, 14 complicating the start-up procedure.

The vapors of the fissionable fuel 12 flow through gap 15, where they directly mix with the surrounding molten salt 10, which includes U238. If the reactivity is low and the temperature is lower than the boiling temperature of 13, the liquid fissionable salt mass is increased where the liquid fissionable fuel 13 flows through the gap 15 until the reactivity increases and the temperature reaches the boiling temperature. The fissionable salt concentration in the surrounding molten salt depends on the temperature, as the surrounding U238, Th, and other eutectic mixture boiling temperatures are equal to or higher than the boiling temperature of the fissionable 18, 13 salts. At the operation condition, the temperature of the 10 will be the boiling temperature of the fissionable fuel where the excessive fissionable fuel salt within 10 bubbles through the liquid 10 and evaporates 8. The reactor heat is recovered from the liquid salt 10 and from the evaporated salt, where a portion of the evaporated salt is condensed on the reactor enclosure wall and on an internal heat exchanger pipe 6, where it flows back and mixed with the liquid surrounding 10, increasing the reactor reactivity. Excessive fissionable fuel can be removed from the reactor to prevent overpressure, condensed in an external condenser (not shown), and recycled back with the reactor fuel 18, 1. The generated heat is recovered by circulating 20 21 heat transfer liquid 3, which can include liquid lead or any other heat transfer fluid.

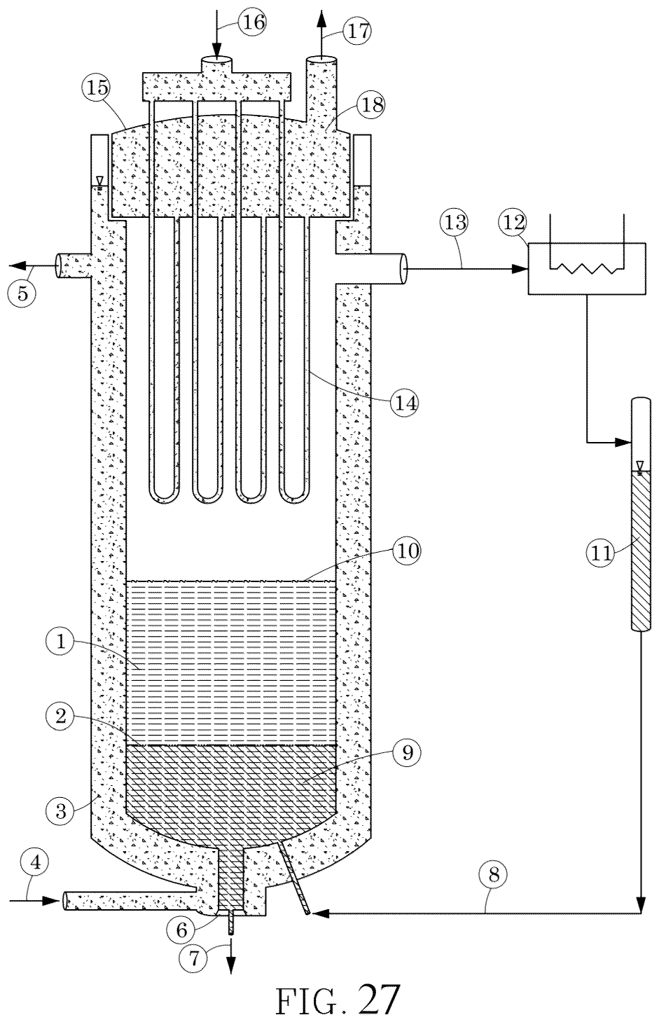

FIG. 27 shows another embodiment of the invention.

A nuclear reactor with an internal boiling core and internal heat exchanger is shown. The reactor internal enclosure 1 is partly filled 1 with low-enrichment UO2 solid particles. The solid particles can be spherical, semi-spherical, cylinders, rings, or any other shape that can be used as packing. There are voids between the partly filled solid particles 1, which allow the flow of liquid molten salt and evaporated salt between the solid particles. Fissionable reactive molten salt fuel 9,8 that can include U235, 233, and Pu fills the gaps between the solids particle 1 and increases the reactor reactivity, increasing the core heat production.

When there is a sufficient amount of liquid nuclear fuel, the reactivity of the core (which is the result of the overall fissionable liquid salt and the solid particles that include lower levels of fissionable fuel and act as reflectors) will generate heat that will boil a portion of the liquid salt 9. The evaporated salt will reduce the reactivity and flow upwards through the solid particles 1,10, where they will come into contact with the internal heat exchanger pipe 14. The internal heat exchanger 14 is protected from the intense radiation by the top layer of the solid particles 10, which act as a reflector and fissionable breeding material. Heat is recovered by the internal heat exchanger 14 while condensing some of the evaporated liquid salt back to liquid form, which flows back to the core to maintain its reactivity. Heat transfer liquid 16, 17 is circulated through the heat exchanger 14. The heat exchanger can be constructed from high-temperature materials that absorb neutrons, like Hafnium. The top section 15 can be lifted from the reactor to allow access to the core.

Any excessive vapor 13 can leave the reactor to a separate condenser 12 where they condensed into liquid molten salt 11. Additional liquid molten salt can be supplied to the reactor bottom 8 to maintain the reactivity. The reactor can be drained from liquid 7 and the solid particles 6 through the bottom plug 6. Heat is extracted from the reactor enclosure with the heat transfer liquid 4, 5. The heat transfer liquid can also be a neutron reflector to increase the reactor reactivity and reduce the radiation. A hick molten lead or lead-bismuth wall can be used as a reflector. The reactor operation temperature will depend on the boiling temperature of the fissionable fuel used. Lower operation temperatures will be obtained using U235/233Cl4 and PuCl4 fissionable salt fuel, while higher operational temperatures will be obtained using U235/233F4 and PuF4 fissionable salt fuel.

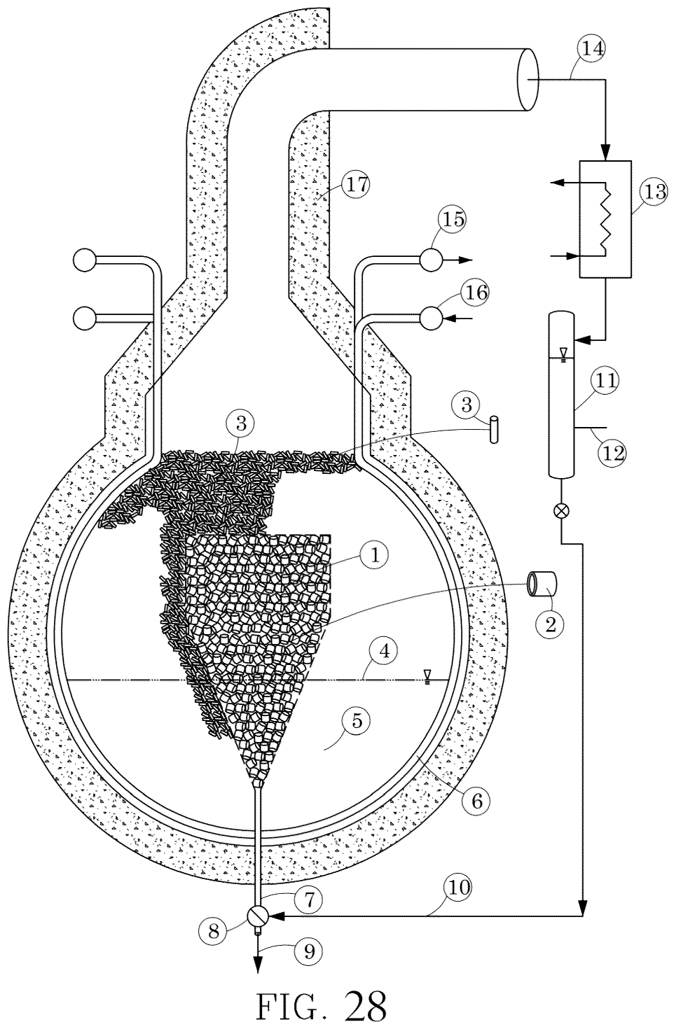

FIG. 28 shows another embodiment of the invention.

A nuclear reactor with an internal boiling core and internal heat exchanger is shown. The reactor internal enclosure surroundings 1 is partly filled 1 with depleted uranium oxide solid particles or thorium oxide solid particles. Used thermal reactor burned fuel, including CANDU deep-burned waste fuel, which is unsuitable for re-processing, can be used. A substantial portion of the long-lived radioactive isotopes within the waste fuel will be “burned” by the intensive fast neutrons. Because of the wide range of self-regulated core reactivity, the neutron poison within the used fuel will be naturally addressed. The solid particles can be spherical, semi-spherical, cylinders, rings, or any other shape that can be used as packing. For example, cylindrical packing fill 3 is shown in the figure. The advantage of the cylindrical shape is that it is commonly sintered and available. There are voids between the partly filled solid particles 3, which allow the flow of liquid molten salt and evaporated salt between the solid particles.

The core center 1 is filled with fissionable enriched uranium oxide or uranium and plutonium oxide solid particles 2. These solid particles prevent the surrounding reflecting/breeding solid oxide particles from filling the core center. In the example, the core center is filled with ring-shaped particles. This allows for a large percent of the void to solid oxide ratio within the core center 1, which allows a larger amount of reactive fissionable molten salt to fill the gaps in the core center. The core center can also use other particle shapes (like spheres, cylinders, rods, etc.). The reactivity of fissionable oxide 2 is well below the reactivity required to maintain a chain reaction in the core.

Fissionable molten salt fuel partly fills the voids between the oxide solid particles of core 1 and the surrounding reflector/breeding particles 3. The fissionable molten salt fuel can include U235, U233, and plutonium in the form of halogen salts. The molten salt fills the bottom of the reactor. It increases its reactivity, where at a certain amount 4, it sustains a chain reaction that generates sufficient heat to boil the fissionable liquid salt, which reduces the reactor reactivity. The boiled salt escapes from core 1,3 in vapor form and fills out from reactor 14 to prevent overpressure as the reactor operates at low pressure, close to the atmospheric pressure and high temperature. Molten salt 10 is supplied 7 to the reactor bottom. The reactor molten fluid salt can be drained 9 to empty the reactor through valve 8.

During operation, it is possible to process a portion of the molten salt 10 to remove contaminates and produce fissionable fuel. Heat is recovered through heat exchanger pipe 6 located around the core close to the reactor enclosure, where it is protected from the intense neutron radiation at the core center by the reflector/breed core solid fill particles 3, which increases the heat exchanger life. Heat-exchanging fluids, like molten metals like sodium, lead, bismuth, etc., can be used. Molten salts heat transfer liquid can be used as well. The heat transfer liquid 15, 16 is transferred to an external heat exchanger where it is used to produce steam.

The reactor is surrounded by external layer 17, which reflects neutrons and reduces the escaping radiation. The arrangement maintains the high reactivity within the core center 1 surrounded by non-reactive reflecting/breeding solid aggregate filling uranium (or thorium) oxides 3, which protects the reactor physical structure (like the heat exchanger 6 and the surrounding enclosure) from the intense radiation (including heat). Fissionable fuel molten salt that boils at high temperatures like U235/233F4, U235/233Cl3, PuF4, and PuCl3 can be used, possibly with additional non-active salts that reduce the melt temperature. The non-active salts can have a higher boiling temperature of the fissionable fuel or about the same. If the non-active boiling temperature is about the same as the fissionable fuel, some will evaporate and be present in vapor gas flow 14. It will also condense and reduce the reactivity and the liquid temperature (eutectic behavior) of the re-condensed liquid salt 11,10. One example is the combination of enriched UF4 and KCl non-active salts. Another example is enriched UCl3 with LiF and NaF non-active salts. The vaporized salt 14 is condensed 13 and accumulated in a liquid form 11. The condensed fissionable liquid salt is maintained below its criticality by designing dimensional configuration and structure materials (neutron absorb).

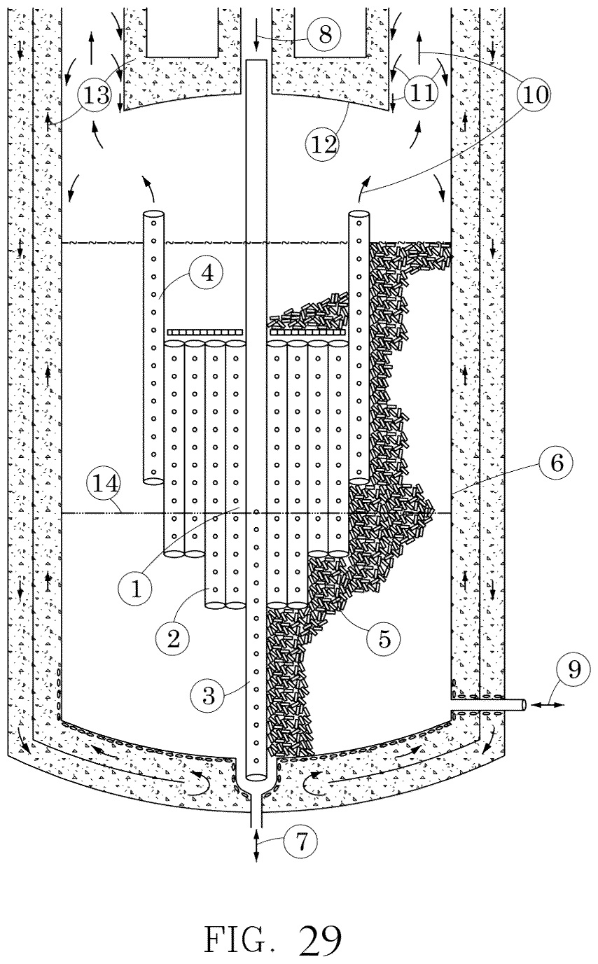

FIG. 29 shows another embodiment of the invention.

A nuclear reactor with an internal boiling core is shown. The core center is surrounded 5 by solid particles of non-falsifiable uranium 238 or thorium oxide used as a reflector and breeding material to produce fissionable fuel, mainly Plutonium or Uranium 233. The solid particles allow fluid to flow through the gaps. In the photo, cylindrical particles are shown. Any other shape can be used as well. Used nuclear fuel, including CANDU spent fuel, can be used as well. The core has an internal volume 1, including multiple perforated pipes 2 that allow liquid molten salt flow and prevent the reflector oxides from filling the core center. Pipes 4 also allow a flow of vapor directly through the reflector packing 5 to allow direct release of vapor from the core without the need for the vapor to filter through the reflector packing 5. Pipe 3 runs through the core center to allow direct drain or fuel supply 7 and also direct access to the core from the top, where fuel 8 can be directly fed into the core during start-up or operation and provide a direct line of sight to the core for fast neutrons or performance monitoring.

The core pipe material should maintain the temperature, radiation, and molten salt chemicals. In contrast to regular solid nuclear fuel cladding, the material doesn't have to be an efficient heat transfer as there is direct contact between the molten liquid and evaporated salt and the surroundings. This allows the use of Zirconium oxide ceramics as well as other ceramic materials. A high heat transfer coefficient is still an advantage, but it is not required, which opens the pipe 2 material selection to additional materials. Vapor 10 is released from the reactor, where some are condensed 11 on the heat transfer reactor walls and drip back to the core.

Heat is recovered from the reactor enclosure surfaces 6 and internal cover 12, including heat transfer surfaces. The heat recovery liquid 13 can include molten metal (like lead and sodium) and molten salt heat transfer. The molten salt fissionable fuel can be supplied from the bottom 7 side 9 or top 8. When the molten salt liquid reaches the criticality level, the chain reaction generates sufficient heat to boil a portion of the salt that is transferred into vapor 10 and released through pipes 4 or through packing 5 upward. The vapor flow is not restricted to avoid overpressure as the reactor pressure is low close to the atmospheric pressure. The criticality is reached within the core void, maintained by pipe 2,3,4 and partly filled with the fissionable molten salt fuel.

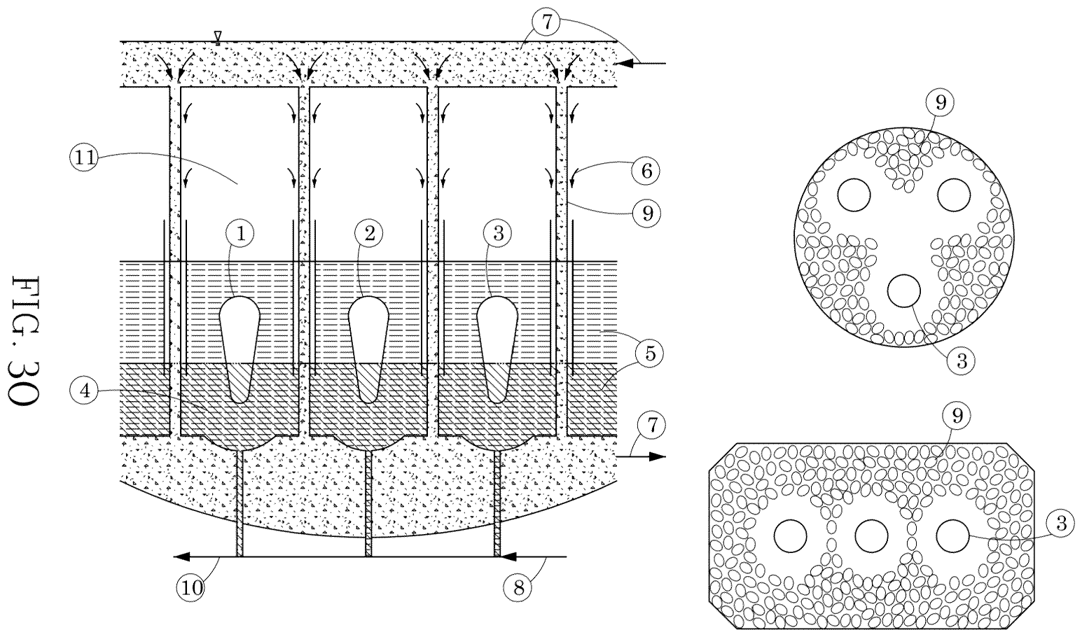

FIG. 30 shows another embodiment of the invention.

A nuclear reactor with multiple internal boiling cores is shown. The figure shows a reactor with 3 cores, 1-3, where other number of cores can be used as well. Each core center is surrounded 5 by a solid particle of non-falsifiable uranium 238 or thorium oxide used as a reflector and breeding material. The core surrounding reduces the intense radiation generated in each core center 1-3 to protect the reactor's physical structure, including the internal heat exchanger pipes 9, from radiation damage and increase their service life. Molten fissionable nuclear fuel salt like U235/233Cl4, U235/233F4, U235/233br4, U235/23314, PuCl4, PuF4, PuBr4 and PuI4 fills the reactor cores bottoms 4, where it become reactive at the cores 1, 2 and 3 that generate heat and temperature to boil excess fissionable fuel to a vapor gas phase 11.

The heat is recovered through heat exchanger pipe 9 and enclosure walls. Heat exchange fluid 7 flows around the reactor enclosure and through the reactor heat transfer pipes 9, where heat is recovered. Fuel salt vapor 11 is condensed on the heat-exchanging surfaces 6 and flows down to the liquid molten salt 4. The core heat is collected through the heat transfer surfaces to circulating heat transfer liquid 7. The heat transfer liquid can be a eutectic molten salt mixture. It can also be a molten metal like sodium, lead, and bismuth mixtures. Excessive vapor gas 11 is free to leave the reactor to prevent reactor over-pressure. The fissionable nuclear salt vapor is condensed back to the liquid phase while recovering the condensation heat. A portion of the condensed fissionable fuel is recycled back to the reactor 8. The reactor reactivity can be reduced by draining a portion or all the fissionable salt 10.

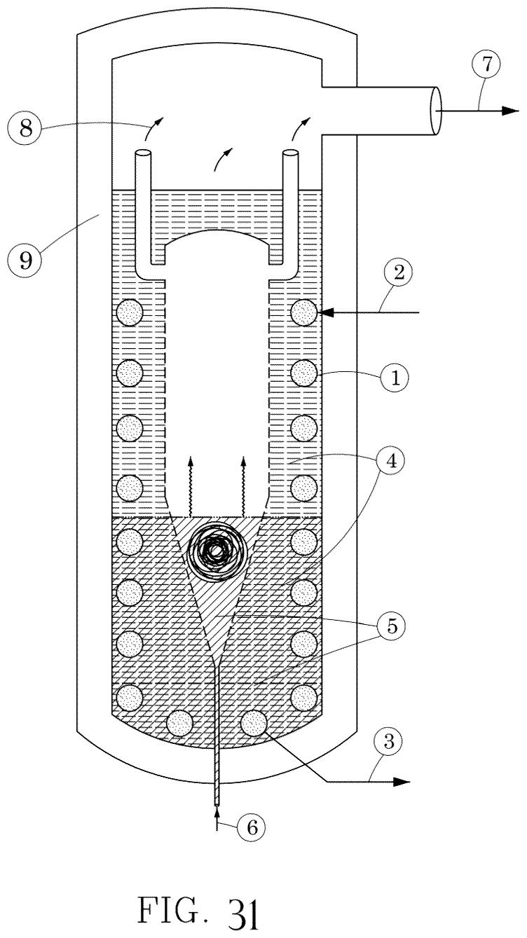

FIG. 31 shows another embodiment of the invention.

A nuclear reactor with internal boiling cores and a heat exchanger is shown. The core includes internal volume surrounded by a volume 4 that contains reflector/breading material like Uranium and thorium oxide, including used uranium oxide fuel. The surrounding volume includes gaps between its particles, allowing molten salt to flow throughout the volume. Fissionable molten salt 5, 6 nuclear fuel that contains U235/233 and Pu halogens salts is supplied to the core internal void where their mass combined with the surrounding reflecting material reaches reactivity at a certain designed volume. The reactivity chain reaction generates heat that increases the temperature of the fissionable fuel salt boiling temperature, which evaporates excessive fissionable fuel.

The reactor includes a large cross-section surrounding heat exchanger coil 1, where heat transfer fluid 2, 3 like molten salt or molten metal, is circulated through the heat exchanger. The heat exchanger is close to the reactor's internal wall, shielding it from the intense core center radiation by the reflecting material 4 to increase its life and reduce the neutron radiation impact on the heat transfer circulated liquid 2, 3. The core containment can be surrounded by an external layer of neutron reflector and radiation shield from depleted uranium and lead, which might include a layer of neutron absorbent material like a bore, cadmium, etc.′ to reduce the escaping radiation further. Excessive molten salt vapor is free to leave the core center 8 and reactor 7 to prevent the reactor from being pressurized. The molten salt vapor 7 is condensed to liquid, where the condensation heat is recovered and recycled back to reactor 6.

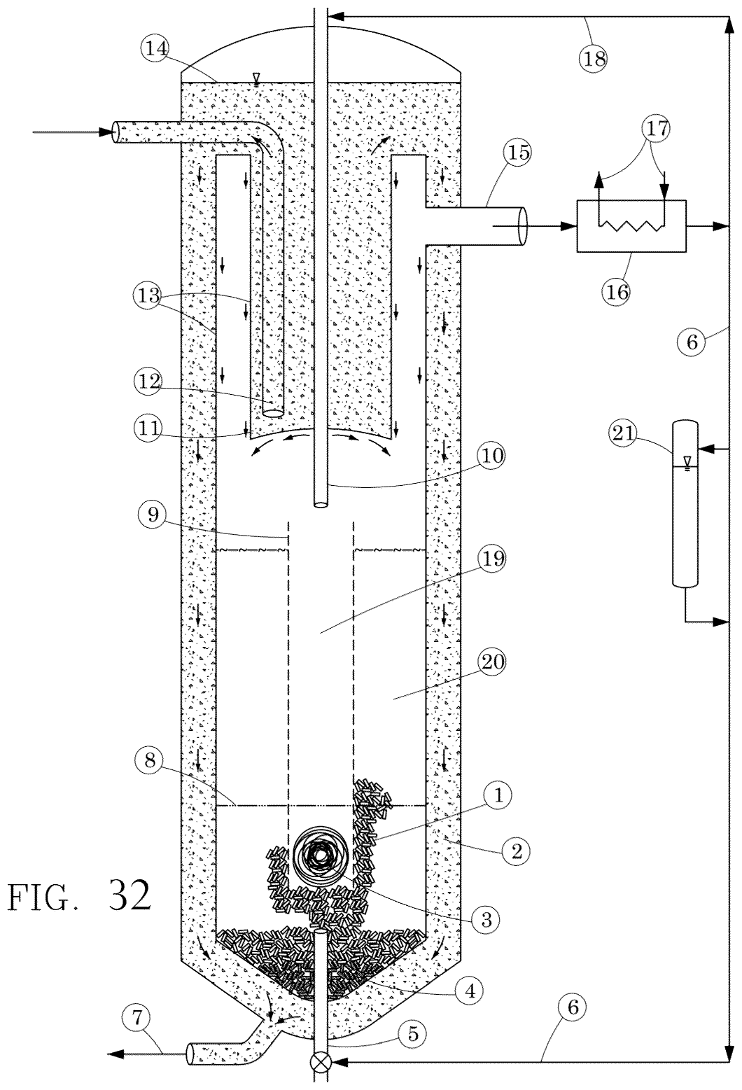

FIG. 32 shows another embodiment of the invention.

A nuclear reactor with internal boiling cores and heat exchange enclosure is shown. The core includes an internal elongated cylindrical (or other elongated shape) volume 19 surrounded by a volume 20 that contains reflector/breeding material like Uranium 238 or Thorium oxide particles. The particles can be cylindrical (shown) or any other shape. Used fuel, including CANDU heavy water, is deeply burned used fuel that burned most of its fissionable plutonium, so it is unsuitable for re-processing, and can also be used to fill volume 20 partly. The reflector/breeding fill 1 allows liquid flow in the gaps between the filling particles. Over time, due to the intense radiation portion of the fill, Uranium 238 or Thorium oxide particles can crack and break, especially if used in nuclear fuel that has already gone through extensive radiation and heat cycles. The break-off reflector debris is heavier than the molten fissionable salt, so it will accumulate over time at the reactor bottom 4 in a way that will not block the flow of the fissionable molten salt fuel 6 that is introduced into the reactor above the potentially affected volume 4 through extension 5.

The reactor internal volume 20 can also include a bottom drain (not shown). The accumulated reflector debris will allow an extension of the operation interval before the maintenance shutdown. After prolonged operation, the reflector, including any potential reflector debris, will include valuable fissionable fuel, like plutonium, in the case of the U238 reflector, which can be re-processed and recovered. The internal reactive volume 19 approaches criticality 3 when it is partly filled with fissionable molten salt 8. The core center 3 reactivity generates heat, which expands the liquid and boils excessive fissionable fuel, which reduces the reactivity and maintains the temperature due to the energy release and heat due to the reactivity under control. The internal volume 19 is maintained by a perforated elongated cylindrical shape 9. This perforated structure keeps the reflector aggregate fill 1 outside of the core center to allow the center high reactivity. The requirement from the material is not the same as the requirement for cladding as it does not have to have a high heat transfer coefficient or seal and maintain pressure. It has to withstand high radiation, heat, and molten salt.

Various materials can be used, including zirconia oxide ceramic, which has good properties but low heat transfer, which is not a problem with this design. Fissionable fuel salt can be supplied to the reactor core from the top 18 through access pipe 10 (like during start-up) or from the bottom 6 through pipe 5. The reactor walls are surrounded by heat transfer liquid 2, where heat is recovered from liquid 7 by circulating it through an external heat exchanger to recover energy. The liquid can be a molten salt, molten oxide, or molten metal. The liquid can also be used as an additional passive reflector if it contains molten lead or lead oxide. The nuclear fuel can include U235/233 or plutonium fluoride, chloride, bromide, or iodide with non-fissionable materials like U238 and thorium salts and additional non-active salts like NaF, NaCl, Nal, KCl, MgCl2 LiF, KF etc′ other salts in eutectic mixture that also reduces the melting point, increase the heat transfer and decrease the nuclear a reactivity. Fissionable fuel vapor is condensed on the internal reactor walls 13, which are cooled by the circulating heat transfer liquid 2, 7. The condensed liquid flows down back to the reactor. Excessive fissionable fuel vapor, possibly with non-fissionable components (like U238 salt vapor) flowing 15 to a condenser 16 where heat is recovered 17 while condensing the vapor back to liquid salt 6. The liquid molten fuel salt 6 can be accumulated in accumulator 21 and recycled back to the reactor from its bottom 5 or top 10.

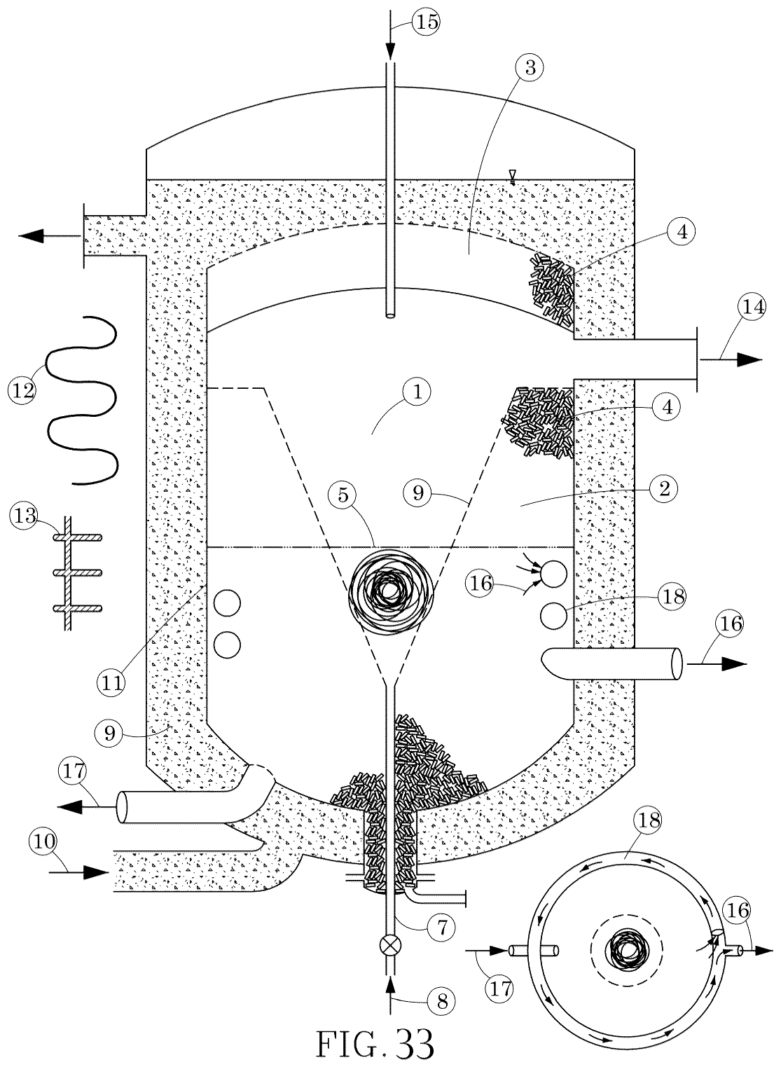

FIG. 33 shows another embodiment of the invention.

A nuclear reactor with internal boiling cores is shown. The core includes internal v shape volume 1 surrounded by reflector/breeding material 2, also included in the reactor top section 3 to capture and reflect the neutron radiation generated at the core. The reflecting material includes solid particles 4 of U238 or thorium. Fissionable nuclear fuel molten salt can flow through the gaps between the solid particles at the surrounding reflecting volume 2. The reactor becomes reactive at a certain level of liquid molten salt 5. The heat boils any excessive fissionable molten salt fuel to balance the reactivity and the heat production. Molten salt can be drained from the reflector particles' packing volume at the reactor bottom. Molten salt can also be drained directly 7 from the reactor V center volume. Fissionable nuclear-molten salt fuel is supplied 8 to the reactor core, where there is direct contact between the core center volume 1 and the surrounding reflector/breeding volume 2.

The core reflector volume is surrounded by heat transfer liquid, which can also be a reflector, like if a molten lead is used. The core surrounding heat transfer liquid is recycled to collect heat transferred through the internal core walls 11. The core enclosure wall can enhance heat transfer by increasing the heat transfer surface 12, fins 13, or any other design. Any excessive fissionable fuel vapor leaves reactor 14, where it is condensed back to the molten salt form with heat recovery and can be recycled back to the reactor from the bottom 8 or the top 15 to maintain and control the reactor reactivity. The molten salt nuclear fuel 16, 17 is circulated through an external heat exchanger (not shown) to recover the generated heat.

Because a portion of the recycled nuclear fuel directly flows from the reactor reactivity area, it goes for spontaneous fission that drastically declines over time. To reduce the circulated nuclear fissionable salt reactivity spontaneous fission before it leaves the reactor, the molten salt is kept in area 18 away from the core center, where the reactivity is low for some time to reduce the spontaneous atom splits and neutron radiation in the core and not in the heat exchanger. This can also be done outside the reactor in an external volume that will keep the fissionable salt circulation fuel for some time to reduce its reactivity before reaching the heat exchanger to increase its life. The same can be done with the vaporized fissionable salt 14 leaving the reactor. However, due to the gas phase, its reactivity will be much lower per volume. Other design options to address this potential reactivity, like using stable construction material or cladding (like metals and ceramics that contain hafnium, which captures neutrons), etc.′. The reactor top, which has a direct line to the boiling core 5, can include reflector/breeding U238 solids similar to 4 solids but in a perforated enclosure submerged in the circulation cooling heat transfer liquid 10. Fissionable salt fuel 15 can also be supplied to the reactor from the top. This supply can be used for the reactor start-up.

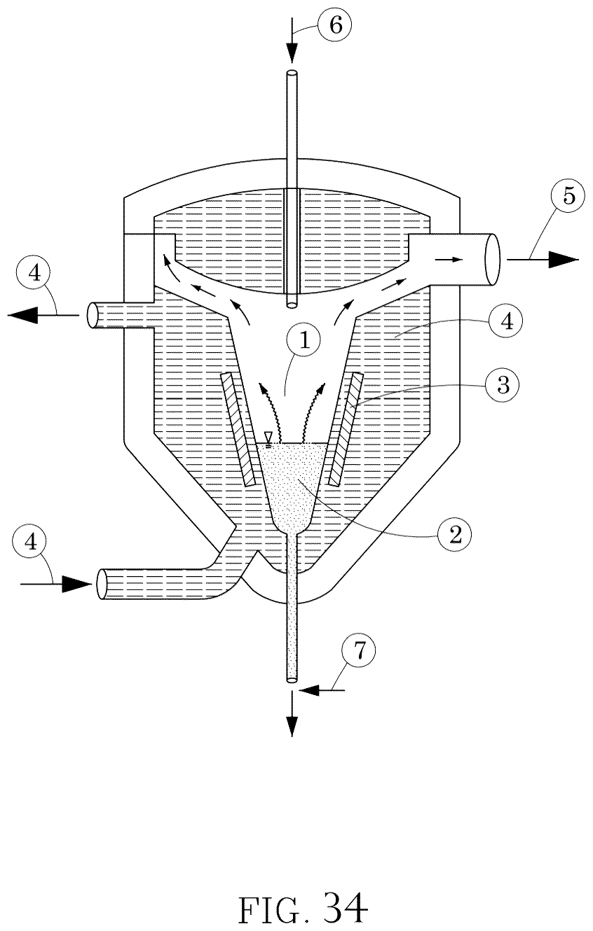

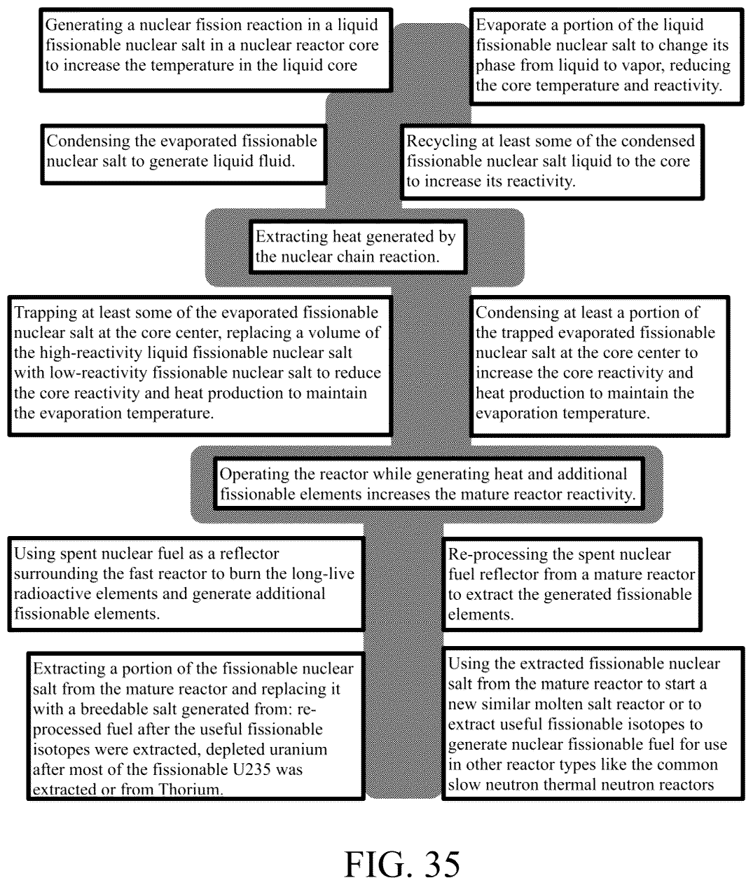

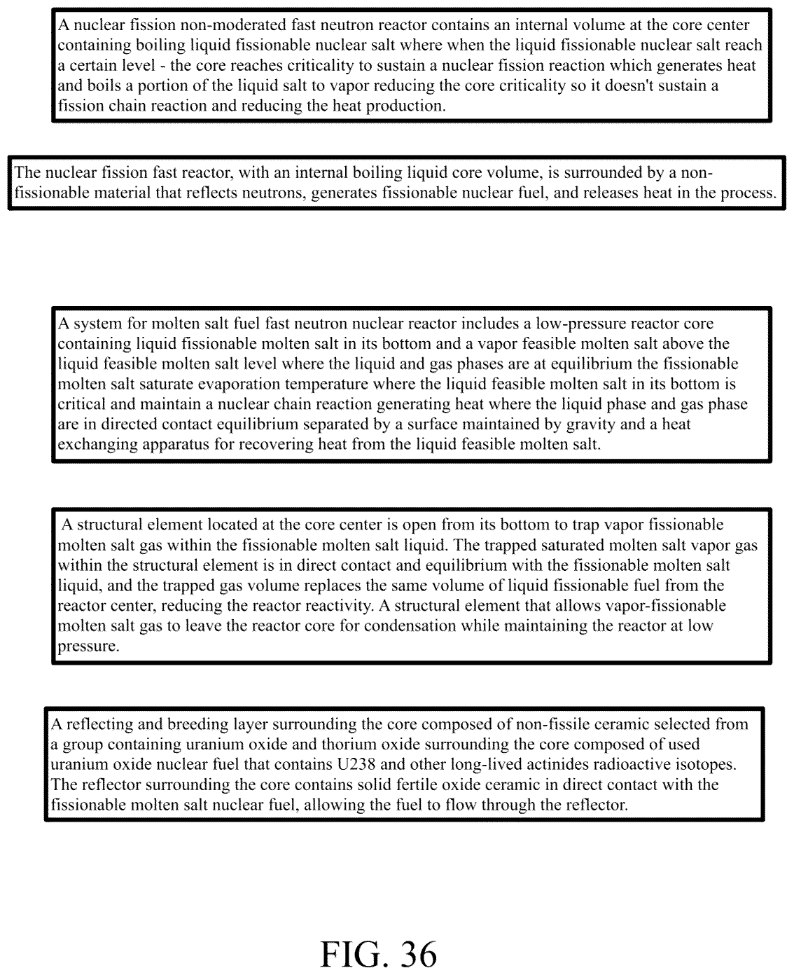

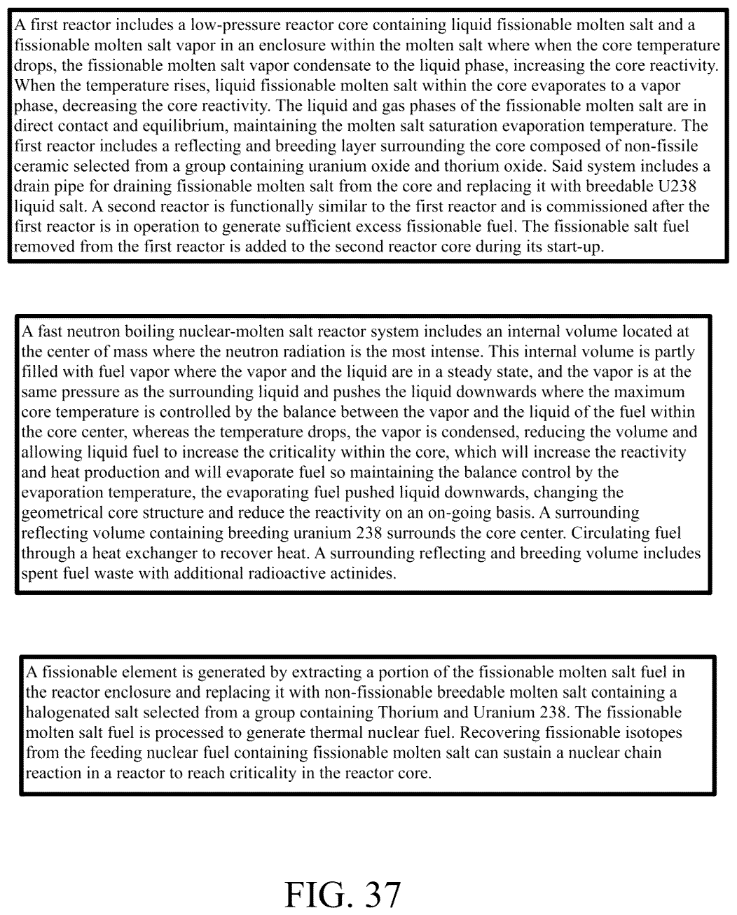

FIG. 34 shows another embodiment of the invention.

A nuclear reactor with an internal boiling core portion surrounded by a heat transfer liquid is shown. The reactor boiling core 2 is surrounded by solid nuclear fuel rods 5 enriched with U235, 233, or plutonium. Heat transfer fluid 4 flows around the nuclear rods to capture and transfer heat. The rods are arranged around a central core enclosure 1, and their reactivity is below the reactivity to sustain a nuclear chain reaction. When the central core volume is partly filled with fissionable molten salt fuel, the reactivity increases to the stage where sufficient heat is generated to evaporate a portion of the fissionable fuel salt 2 to a vapor state where it leaves the reactor 5.

A reflector layer surrounds heat transfer fluid 4. The reflector can be made from U238, lead, or any other material reflecting the neutrons to the core. The condensed fissionable salt fuel is recycled back to the reactor to maintain its reactivity from the bottom 7 or the top 6. The heat transfer liquid 4 recovers heat generated by the fuel rods 3 and the molten salt partly filed core 2. The heat transfer liquid can be molten sodium, molten lead, lead-bismuth, or eutectic molten salt mixture like NaCl, KCl, MgCl2, etc′. The fissionable molten salt can include U235Cl4, PuCl4, and other fissionable chloride, fluoride, bromide, or iodide molten salt. Non-fissionable U238 is included in the fissionable fuel to reduce the fuel reactivity and breed additional fissionable fuel, mainly plutonium. The fissionable salt fuel vapor leaving reactor 5 is condensed in an external condenser, possibly with the same heat-exchanging liquid 4 used to recover heat in the reactor.

1. A method to generate heat energy for electricity form a molten salt fuel fast neutron nuclear reactor, the method comprising the following steps:
feeding nuclear fuel containing fissionable molten salt that can sustain nuclear chain reaction into a reactor;
increasing the amount of the fissionable molten salt fuel in the reactor enclosure until it reaches criticality;
generating heat from the criticality chain reaction while heating the fissionable molten salt fuel;
boiling portion of the fissionable molten salt fuel with the generated heat to generate gas phase fuel while reducing the criticality;
condensing the gas phase fuel back to a liquid phase; and
recycle at least a portion of the liquid phase molten salt nuclear fuel back to the reactor.

2. A method to generate heat energy for electricity form a molten salt fuel fast neutron nuclear reactor, the method comprising the following steps:
feeding nuclear fuel containing fissionable molten salt that can sustain nuclear chain reaction into a reactor to reaches criticality in the reactor core;
generating heat from the criticality chain reaction while heating the fissionable molten salt fuel;
boiling portion of the feasible molten salt fuel with the generated heat to generate salt fuel gas;
capturing the generated salt fuel gas in an enclosure which is open at it's bottom within the reactor core while reducing the criticality;
controlling the reactor criticality by the temperature based balance between the condensation and evaporation of the fissionable molten salt fuel;
extracting heat from the liquid phase molten salt nuclear fuel.

3. The method to generate heat energy of claim 1, wherein said fissionable molten salt fuel is selected from a group containing salts of Uranium233, Uranium 235, and plutonium with Halogens selected from the group containing Fluorine, Chlorine, Bromine, and Iodine.

4. The method to generate heat energy of claim 1, wherein the reactor is comprised of a fast neutron reflector material containing at least one of Uranium 238 and Thorium, which can generate fissionable fuel.

5. The method to generate heat energy of claim 1, wherein the reflector surrounding the core contain packing of solid fertile oxide ceramic particles selected from a group containing: Uranium oxide, thorium oxide and spent uranium oxide nuclear fuel.

6. The method to generate heat energy of claim 1, wherein the reflector surrounding the core contains solid fertile oxide ceramic in a direct contact with the fissionable molten salt nuclear fuel allowing the fuel to flow through the reflector.

7. The method to generate heat energy of claim 3, wherein at least a portion of the Uranium 238 and Thorium are in a salt chemical composition with halogens.

8. The method to generate heat energy of claim 4, wherein at least a portion of said Uranium 238 and Thorium are comprised of solid Uranium Oxide and Thorium Oxide.

9. The method to generate heat energy of claim 2, wherein said feasible salt contains non-fissionable molten salt containing metal selected from a group containing Li, Na, K, Ca, Be, Mg, Bi and Pb with halogen are selected from the group containing F, Cl, Br and I or O.

10. The method to generate heat energy of claim 1, wherein high-pressure steam for electricity production is generated from the heat recovered from the nuclear-molten salt fuel condensation and heat recovered from the reactor.

11. (canceled)

12. The method to generate heat energy of claim 1, further comprising the steps of:
operating the method at a nuclear facility while increasing the reactivity of the molten salt fuel due to the generation of additional fissionable elements from the breadable elements within the molten salt fuel;
removing portion of the molten salt;
adding a breadable elements to replace the fuel removed from the original cycle, said elements include the halogen salt containing at least one element selected from the following group: Uranium 238 and Thorium; and
using the remove molten salt to perform at least one of the following two actions: start a new similar nuclear facility that operates on a similar nuclear molten salt fuel and extract plutonium for use in slow thermal nuclear reactors.

13. (canceled)

14. A system to generate heat energy for electricity, comprising:
a molten salt fuel fast neutron nuclear reactor,
wherein the reactor comprises:
a low pressure reactor core containing liquid fissionable molten salt in a bottom and a vapor feasible molten salt above the liquid feasible molten salt level where the liquid and gas phases are at an equilibrium the fissionable molten salt saturate evaporation temperature where the liquid liquid feasible molten salt in it's bottom is critical and maintain a nuclear chain reaction generating heat where the liquid phase and gas phase are in directed contact equilibrium separated by a surface maintained by gravity; and
a heat exchanging apparatus for recovering heat from the liquid molten salt.

15. The system to generate heat of claim 14, further comprising:
a structural element located at the core center open from it's bottom for trapping vapor fissionable molten salt gas within the fissionable molten salt liquid where the trapped saturate molten salt vapor gas within the structural element is in direct contact and in equilibrium with the fissionable molten salt liquid; and
the trapped gas volume replacing the same volume of liquid fissionable fuel from the reactor center, reducing the reactor reactivity.

16. The system to generate heat of claim 14, further comprising:
a structural element for allowing vapor fissionable molten salt gas to leave the reactor core for condensation while maintaining the reactor at low pressure.

17. The system to generate heat of claim 14, further comprising:
a reflecting and breeding layer surrounding the core composed of non-fissile ceramic selected from a group containing uranium oxide and thorium oxide.

18. The system to generate heat of claim 14, further comprising:
a reflecting and breeding layer surrounding the core comprised of spent uranium oxide nuclear fuel that contains U238 and other long live actinides radioactive isotopes.

19. The system to generate heat of claim 17, wherein the reflecting and breeding layer surrounding the core comprises solid fertile oxide ceramic in a direct contact with the fissionable molten salt nuclear fuel allowing the fuel to flow through the reflector.

20. The system to generate heat of claim 14,
wherein the molten salt fuel fast neutron nuclear reactor is
a first reactor include a low pressure reactor core containing liquid fissionable molten salt and a fissionable molten salt vapor in an enclosure within the molten salt where when the core temperature drops the fissionable molten salt vapor condensate to the liquid phase increasing the core reactivity. When the temperature rise, liquid fissionable molten salt within the core evaporates to a vapor phase decreasing the core reactivity. The liquid and gas phases of the fissionable molten salt are in a direct contact and in an equilibrium maintaining the molten salt saturate evaporation temperature. The first reactor include a reflecting and breeding layer surrounding the core composed of non-fissile ceramic selected from a group containing uranium oxide and thorium oxide. Said system include a drain pipe for draining fissionable molten salt from the core and replacing it with breadable U238 liquid salt.

21. The system to generate heat of claim 20, further comprising:
a second reactor functionally similar to said first reactor, said second reactor commissioned after the first reactor is in operation to generate sufficient excess fissionable fuel. The fissionable salt fuel remove from the first reactor is added to the second reactor core during it's start-up.

22. The system to generate heat of claim 14, wherein the molten salt fuel fast neutron nuclear reactor further comprises:
an internal volume located at the central of mass where the neutron radiation is the most intense this internal volume is partly filled with fuel vapor where the vapor and the liquid are in a steady state, and the vapor is at the same pressure as the surrounding liquid and pushes the liquid downwards where the maximum core temperature is controlled by the balance between the vapor and the liquid of the fuel within the core center, whereas the temperature drops, the vapor is condensed, reducing the volume and allowing liquid fuel to increase the criticality within the core, which will increase the reactivity and heat production and will evaporate fuel so maintaining the balance control by the evaporation temperature, the evaporating fuel pushed liquid downwards, changing the geometrical core structure and reduce the reactivity on an on-going basis;
a surrounding reflecting and breeding volume containing breeding uranium 238 surrounding the core center, wherein the U238 is sourced from at least one of the following: spent fuel waste with additional radioactive actinides and depleted uranium after most of the valuable U235 was recovered; and
a circulating fuel through a heat exchanger to recover heat.
